(19) United States
(12) Patent Application Publication
(10) Pub. No.: US 2026/0231182 A1
(43) Pub. Date: Aug. 6, 2026

(54) MATCHING BANDWIDTH BETWEEN PHYSICAL SIDELINK CONTROL CHANNEL (PSCCH) AND SIDELINK POSITIONING REFERENCE SIGNALS (SL-PRS)

(71) Applicant: QUALCOMM Incorporated, San Diego, CA (US)

(72) Inventors: Jeya Pradha JEYARAJ, San Diego, CA (US); Gabi SARKIS, San Diego, CA (US); Alexandros MANOLAKOS, Athens (GR)

(21) Appl. No.: 19/147,938

(22) PCT Filed: Jan. 5, 2024
(86) PCT No.: PCT/US2024/010400

§ 371 Date: Jul. 14, 2025

(30) Foreign Application Priority Data
Feb. 17, 2023 (GR) 20230100141

(51) Int. Cl. H04W 72/25; H04W 64/00

(52) U.S. Cl. CPC H04W 72/25; H04W 64/00

(57) ABSTRACT

In an aspect, a wireless communication device may transmit or receive a physical sidelink control channel (PSCCH). The wireless communication device may transmit or receive one or more sidelink positioning reference signals (SL-PRS), wherein the one or more SL-PRS and the PSCCH are transmitted or received with a same bandwidth in a same slot.

### BACKGROUND OF THE DISCLOSURE

### 1. Field of the Disclosure

Aspects of the disclosure relate generally to wireless communications.

### 2. Description of the Related Art

Wireless communication systems have developed through various generations, including a first-generation analog wireless phone service (1G), a second-generation (2G) digital wireless phone service (including interim 2.5G and 2.75G networks), a third-generation (3G) high speed data, Internet-capable wireless service and a fourth-generation (4G) service (e.g., Long Term Evolution (LTE) or WiMax). There are presently many different types of wireless communication systems in use, including cellular and personal communications service (PCS) systems. Examples of known cellular systems include the cellular analog advanced mobile phone system (AMPS), and digital cellular systems based on code division multiple access (CDMA), frequency division multiple access (FDMA), time division multiple access (TDMA), the Global System for Mobile communications (GSM), etc.

A fifth generation (5G) wireless standard, referred to as New Radio (NR), enables higher data transfer speeds, greater numbers of connections, and better coverage, among other improvements. The 5G standard, according to the Next Generation Mobile Networks Alliance, is designed to provide higher data rates as compared to previous standards, more accurate positioning (e.g., based on reference signals for positioning (RS-P), such as downlink, uplink, or sidelink positioning reference signals (PRS)) and other technical enhancements.

Leveraging the increased data rates and decreased latency of 5G, among other things, vehicle-to-everything (V2X) communication technologies are being implemented to support autonomous driving applications, such as wireless communications between vehicles, between vehicles and the roadside infrastructure, between vehicles and pedestrians, etc.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary has the sole purpose to present certain concepts relating to one or more aspects relating to the mechanisms disclosed herein in a simplified form to precede the detailed description presented below.

In an aspect, a method of wireless communication performed by a wireless communication device includes transmitting or receiving a physical sidelink control channel (PSCCH); and transmitting or receiving one or more sidelink positioning reference signals (SL-PRS), wherein the one or more SL-PRS and the PSCCH are transmitted or received with a same bandwidth in a same slot.

In an aspect, a method of wireless communication performed by a wireless communication device includes receiving or transmitting a physical sidelink control channel (PSCCH) in a slot, wherein the PSCCH spans a first bandwidth in the slot; receiving or transmitting a physical sidelink shared channel (PSSCH) in the slot, wherein the PSSCH spans at least a second bandwidth adjacent to the first bandwidth; and receiving or transmitting one or more sidelink positioning reference signals (SL-PRS) in the slot, wherein the one or more SL-PRS span a third bandwidth, wherein the third bandwidth corresponds to a sum of the first bandwidth and the second bandwidth.

In an aspect, a method of wireless communication performed by a wireless communication device includes transmitting or receiving a physical sidelink control channel (PSCCH) in one or more symbols of a slot; and transmitting or receiving one or more sidelink positioning reference signals (SL-PRS) in the one or more symbols of the slot, wherein the one or more SL-PRS and the PSCCH are frequency division multiplexed within the one or more symbols of the slot and have a same number of symbols.

In an aspect, a wireless communication device includes a memory; at least one transceiver; and at least one processor communicatively coupled to the memory and the at least one transceiver, the at least one processor configured to: transmit or receive, via the at least one transceiver, a physical sidelink control channel (PSCCH); and transmit or receive, via the at least one transceiver, one or more sidelink positioning reference signals (SL-PRS), wherein the one or more SL-PRS and the PSCCH are transmitted or received with a same bandwidth in a same slot.

In an aspect, a wireless communication device includes a memory; at least one transceiver; and at least one processor communicatively coupled to the memory and the at least one transceiver, the at least one processor configured to: receive or transmit, via the at least one transceiver, a physical sidelink control channel (PSCCH) in a slot, wherein the PSCCH spans a first bandwidth in the slot; receive or transmit, via the at least one transceiver, a physical sidelink shared channel (PSSCH) in the slot, wherein the PSSCH spans at least a second bandwidth adjacent to the first bandwidth; and receive or transmit, via the at least one transceiver, one or more sidelink positioning reference signals (SL-PRS) in the slot, wherein the one or more SL-PRS span a third bandwidth, wherein the third bandwidth corresponds to a sum of the first bandwidth and the second bandwidth.

In an aspect, a wireless communication device includes a memory; at least one transceiver; and at least one processor communicatively coupled to the memory and the at least one transceiver, the at least one processor configured to: transmit or receive, via the at least one transceiver, a physical sidelink control channel (PSCCH) in one or more symbols of a slot; and transmit or receive, via the at least one transceiver, one or more sidelink positioning reference signals (SL-PRS) in the one or more symbols of the slot, wherein the one or more SL-PRS and the PSCCH are frequency division multiplexed within the one or more symbols of the slot and have a same number of symbols.

In an aspect, a wireless communication device includes means for transmitting or receiving a physical sidelink control channel (PSCCH); and means for transmitting or receiving one or more sidelink positioning reference signals (SL-PRS), wherein the one or more SL-PRS and the PSCCH are transmitted or received with a same bandwidth in a same slot.

In an aspect, a wireless communication device includes means for receiving or transmitting a physical sidelink control channel (PSCCH) in a slot, wherein the PSCCH spans a first bandwidth in the slot; means for receiving or transmitting a physical sidelink shared channel (PSSCH) in the slot, wherein the PSSCH spans at least a second bandwidth adjacent to the first bandwidth; and means for receiving or transmitting one or more sidelink positioning reference signals (SL-PRS) in the slot, wherein the one or more SL-PRS span a third bandwidth, wherein the third bandwidth corresponds to a sum of the first bandwidth and the second bandwidth.

In an aspect, a wireless communication device includes means for transmitting or receiving a physical sidelink control channel (PSCCH) in one or more symbols of a slot; and means for transmitting or receiving one or more sidelink positioning reference signals (SL-PRS) in the one or more symbols of the slot, wherein the one or more SL-PRS and the PSCCH are frequency division multiplexed within the one or more symbols of the slot and have a same number of symbols.

In an aspect, a non-transitory computer-readable medium storing computer-executable instructions that, when executed by a wireless communication device, cause the wireless communication device to: transmit or receive a physical sidelink control channel (PSCCH); and transmit or receive one or more sidelink positioning reference signals (SL-PRS), wherein the one or more SL-PRS and the PSCCH are transmitted or received with a same bandwidth in a same slot.

In an aspect, a non-transitory computer-readable medium storing computer-executable instructions that, when executed by a wireless communication device, cause the wireless communication device to: transmit or receive a physical sidelink control channel (PSCCH) in one or more symbols of a slot; and transmit or receive one or more sidelink positioning reference signals (SL-PRS) in the one or more symbols of the slot, wherein the one or more SL-PRS and the PSCCH are frequency division multiplexed within the one or more symbols of the slot and have a same number of symbols.

Other objects and advantages associated with the aspects disclosed herein will be apparent to those skilled in the art based on the accompanying drawings and detailed description.

### BRIEF DESCRIPTION OF THE DRAWINGS

The accompanying drawings are presented to aid in the description of various aspects of the disclosure and are provided solely for illustration of the aspects and not limitation thereof.

FIG. 1 illustrates an example wireless communications system, according to aspects of the disclosure.

FIGS. 2A and 2B illustrate example wireless network structures, according to aspects of the disclosure.

FIGS. 3A, 3B, and 3C are simplified block diagrams of several sample aspects of components that may be employed in a user equipment (UE), a base station, and a network entity, respectively, and configured to support communications as taught herein.

FIG. 4 illustrates the two resource allocation modes for transmissions on a sidelink, according to aspects of the disclosure.

FIG. 5 is a diagram showing how a shared channel (SCH) is established on a sidelink between two or more UEs, according to aspects of the disclosure.

FIG. 6 is a diagram illustrating an example sidelink ranging and positioning procedure, according to aspects of the disclosure.

FIGS. 7A and 7B are diagrams of example sidelink slot structures with and without feedback resources, according to aspects of the disclosure.

FIG. 8 illustrates example demodulation reference signal (DMRS) patterns for nine and twelve symbol physical sidelink shared channel (PSSCH), according to aspects of the disclosure.

FIG. 9 shows an example of a slot structure having dedicated sidelink positioning reference signals (SL-PRS), according to aspects of the disclosure.

FIG. 10 shows an example of a slot structure having dedicated SL-PRS from a sidelink resource pool, according to aspects of the disclosure.

FIG. 11 shows another example of a slot structure having dedicated SL-PRS from a sidelink resource pool, according to aspects of the disclosure.

FIG. 12 shows another example of a slot structure having dedicated SL-PRS from a sidelink resource pool, according to aspects of the disclosure.

FIG. 13 illustrates an example method of wireless communication performed by a UE, according to aspects of the disclosure.

FIG. 14 illustrates an example method of wireless communication performed by a wireless communication device, according to aspects of the disclosure.

FIG. 15 illustrates an example method of wireless communication performed by a wireless communication device, according to aspects of the disclosure.

### DETAILED DESCRIPTION

Aspects of the disclosure are provided in the following description and related drawings directed to various examples provided for illustration purposes. Alternate aspects may be devised without departing from the scope of the disclosure. Additionally, well-known elements of the disclosure will not be described in detail or will be omitted so as not to obscure the relevant details of the disclosure.

The words “exemplary” and/or “example” are used herein to mean “serving as an example, instance, or illustration.” Any aspect described herein as “exemplary” and/or “example” is not necessarily to be construed as preferred or advantageous over other aspects. Likewise, the term “aspects of the disclosure” does not require that all aspects of the disclosure include the discussed feature, advantage or mode of operation.

Those of skill in the art will appreciate that the information and signals described below may be represented using any of a variety of different technologies and techniques. For example, data, instructions, commands, information, signals, bits, symbols, and chips that may be referenced throughout the description below may be represented by voltages, currents, electromagnetic waves, magnetic fields or particles, optical fields or particles, or any combination thereof, depending in part on the particular application, in part on the desired design, in part on the corresponding technology, etc.

Further, many aspects are described in terms of sequences of actions to be performed by, for example, elements of a computing device. It will be recognized that various actions described herein can be performed by specific circuits (e.g., application specific integrated circuits (ASICs)), by program instructions being executed by one or more processors, or by a combination of both. Additionally, the sequence(s) of actions described herein can be considered to be embodied entirely within any form of non-transitory computer-readable storage medium having stored therein a corresponding set of computer instructions that, upon execution, would cause or instruct an associated processor of a device to perform the functionality described herein. Thus, the various aspects of the disclosure may be embodied in a number of different forms, all of which have been contemplated to be within the scope of the claimed subject matter. In addition, for each of the aspects described herein, the corresponding form of any such aspects may be described herein as, for example, “logic configured to” perform the described action.

As used herein, the terms “user equipment” (UE), “vehicle UE” (V-UE), “pedestrian UE” (P-UE), and “base station” are not intended to be specific or otherwise limited to any particular radio access technology (RAT), unless otherwise noted. In general, a UE may be any wireless communication device (e.g., vehicle on-board computer, vehicle navigation device, mobile phone, router, tablet computer, laptop computer, asset locating device, wearable (e.g., smartwatch, glasses, augmented reality (AR)/virtual reality (VR) headset, etc.), vehicle (e.g., automobile, motorcycle, bicycle, etc.), Internet of Things (IoT) device, etc.) used by a user to communicate over a wireless communications network. A UE may be mobile or may (e.g., at certain times) be stationary, and may communicate with a radio access network (RAN). As used herein, the term “UE” may be referred to interchangeably as a “mobile device,” an “access terminal” or “AT,” a “client device,” a “wireless device,” a “subscriber device,” a “subscriber terminal,” a “subscriber station,” a “user terminal” or UT, a “mobile terminal,” a “mobile station,” or variations thereof.

A V-UE is a type of UE and may be any in-vehicle wireless communication device, such as a navigation system, a warning system, a heads-up display (HUD), an on-board computer, an in-vehicle infotainment system, an automated driving system (ADS), an advanced driver assistance system (ADAS), etc. Alternatively, a V-UE may be a portable wireless communication device (e.g., a cell phone, tablet computer, etc.) that is carried by the driver of the vehicle or a passenger in the vehicle. The term “V-UE” may refer to the in-vehicle wireless communication device or the vehicle itself, depending on the context. A P-UE is a type of UE and may be a portable wireless communication device that is carried by a pedestrian (i.e., a user that is not driving or riding in a vehicle). Generally, UEs can communicate with a core network via a RAN, and through the core network the UEs can be connected with external networks such as the Internet and with other UEs. Of course, other mechanisms of connecting to the core network and/or the Internet are also possible for the UEs, such as over wired access networks, wireless local area network (WLAN) networks (e.g., based on Institute of Electrical and Electronics Engineers (IEEE) 802.11, etc.) and so on.

A base station may operate according to one of several RATs in communication with UEs depending on the network in which it is deployed, and may be alternatively referred to as an access point (AP), a network node, a NodeB, an evolved NodeB (eNB), a next generation eNB (ng-eNB), a New Radio (NR) Node B (also referred to as a gNB or gNodeB), etc. A base station may be used primarily to support wireless access by UEs including supporting data, voice and/or signaling connections for the supported UEs. In some systems a base station may provide purely edge node signaling functions while in other systems it may provide additional control and/or network management functions. A communication link through which UEs can send signals to a base station is called an uplink (UL) channel (e.g., a reverse traffic channel, a reverse control channel, an access channel, etc.). A communication link through which the base station can send signals to UEs is called a downlink (DL) or forward link channel (e.g., a paging channel, a control channel, a broadcast channel, a forward traffic channel, etc.). As used herein the term traffic channel (TCH) can refer to either an UL/reverse or DL/forward traffic channel.

The term “base station” may refer to a single physical transmission-reception point (TRP) or to multiple physical TRPs that may or may not be co-located. For example, where the term “base station” refers to a single physical TRP, the physical TRP may be an antenna of the base station corresponding to a cell (or several cell sectors) of the base station. Where the term “base station” refers to multiple co-located physical TRPs, the physical TRPs may be an array of antennas (e.g., as in a multiple-input multiple-output (MIMO) system or where the base station employs beamforming) of the base station. Where the term “base station” refers to multiple non-co-located physical TRPs, the physical TRPs may be a distributed antenna system (DAS) (a network of spatially separated antennas connected to a common source via a transport medium) or a remote radio head (RRH) (a remote base station connected to a serving base station). Alternatively, the non-co-located physical TRPs may be the serving base station receiving the measurement report from the UE and a neighbor base station whose reference radio frequency (RF) signals the UE is measuring. Because a TRP is the point from which a base station transmits and receives wireless signals, as used herein, references to transmission from or reception at a base station are to be understood as referring to a particular TRP of the base station.

In some implementations that support positioning of UEs, a base station may not support wireless access by UEs (e.g., may not support data, voice, and/or signaling connections for UEs), but may instead transmit reference RF signals to UEs to be measured by the UEs and/or may receive and measure signals transmitted by the UEs. Such base stations may be referred to as positioning beacons (e.g., when transmitting RF signals to UEs) and/or as location measurement units (e.g., when receiving and measuring RF signals from UEs).

An “RF signal” comprises an electromagnetic wave of a given frequency that transports information through the space between a transmitter and a receiver. As used herein, a transmitter may transmit a single “RF signal” or multiple “RF signals” to a receiver. However, the receiver may receive multiple “RF signals” corresponding to each transmitted RF signal due to the propagation characteristics of RF signals through multipath channels. The same transmitted RF signal on different paths between the transmitter and receiver may be referred to as a “multipath” RF signal. As used herein, an RF signal may also be referred to as a “wireless signal” or simply a “signal” where it is clear from the context that the term “signal” refers to a wireless signal or an RF signal.

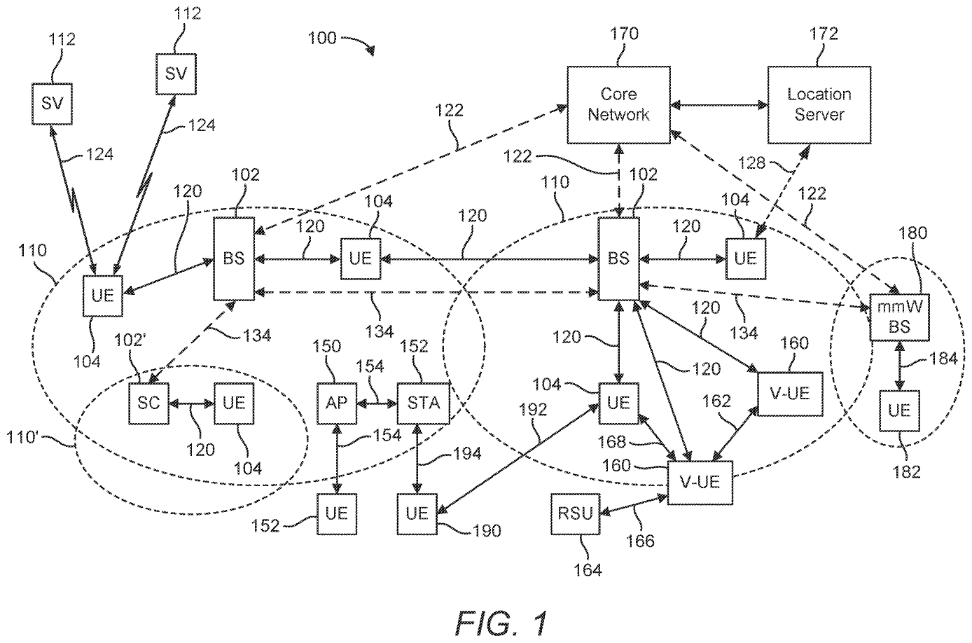

FIG. 1 illustrates an example wireless communications system 100, according to aspects of the disclosure. The wireless communications system 100 (which may also be referred to as a wireless wide area network (WWAN)) may include various base stations 102 (labelled “BS”) and various UEs 104. The base stations 102 may include macro cell base stations (high power cellular base stations) and/or small cell base stations (low power cellular base stations). In an aspect, the macro cell base stations 102 may include eNBs and/or ng-eNBs where the wireless communications system 100 corresponds to an LTE network, or gNBs where the wireless communications system 100 corresponds to a NR network, or a combination of both, and the small cell base stations may include femtocells, picocells, microcells, etc.

The base stations 102 may collectively form a RAN and interface with a core network 170 (e.g., an evolved packet core (EPC) or 5G core (5GC)) through backhaul links 122, and through the core network 170 to one or more location servers 172 (e.g., a location management function (LMF) or a secure user plane location (SUPL) location platform (SLP)). The location server(s) 172 may be part of core network 170 or may be external to core network 170. A location server 172 may be integrated with a base station 102. A UE 104 may communicate with a location server 172 directly or indirectly. For example, a UE 104 may communicate with a location server 172 via the base station 102 that is currently serving that UE 104. A UE 104 may also communicate with a location server 172 through another path, such as via an application server (not shown), via another network, such as via a wireless local area network (WLAN) access point (AP) (e.g., AP 150 described below), and so on. For signaling purposes, communication between a UE 104 and a location server 172 may be represented as an indirect connection (e.g., through the core network 170, etc.) or a direct connection (e.g., as shown via direct connection 128), with the intervening nodes (if any) omitted from a signaling diagram for clarity.

In addition to other functions, the base stations 102 may perform functions that relate to one or more of transferring user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, RAN sharing, multimedia broadcast multicast service (MBMS), subscriber and equipment trace, RAN information management (RIM), paging, positioning, and delivery of warning messages. The base stations 102 may communicate with each other directly or indirectly (e.g., through the EPC/5GC) over backhaul links 134, which may be wired or wireless.

The base stations 102 may wirelessly communicate with the UEs 104. Each of the base stations 102 may provide communication coverage for a respective geographic coverage area 110. In an aspect, one or more cells may be supported by a base station 102 in each geographic coverage area 110. A “cell” is a logical communication entity used for communication with a base station (e.g., over some frequency resource, referred to as a carrier frequency, component carrier, carrier, band, or the like), and may be associated with an identifier (e.g., a physical cell identifier (PCI), an enhanced cell identifier (ECI), a virtual cell identifier (VCI), a cell global identifier (CGI), etc.) for distinguishing cells operating via the same or a different carrier frequency. In some cases, different cells may be configured according to different protocol types (e.g., machine-type communication (MTC), narrowband IoT (NB-IoT), enhanced mobile broadband (eMBB), or others) that may provide access for different types of UEs. Because a cell is supported by a specific base station, the term “cell” may refer to either or both the logical communication entity and the base station that supports it, depending on the context. In some cases, the term “cell” may also refer to a geographic coverage area of a base station (e.g., a sector), insofar as a carrier frequency can be detected and used for communication within some portion of geographic coverage areas 110.

While neighboring macro cell base station 102 geographic coverage areas 110 may partially overlap (e.g., in a handover region), some of the geographic coverage areas 110 may be substantially overlapped by a larger geographic coverage area 110. For example, a small cell base station 102′ (labelled “SC” for “small cell”) may have a geographic coverage area 110′ that substantially overlaps with the geographic coverage area 110 of one or more macro cell base stations 102. A network that includes both small cell and macro cell base stations may be known as a heterogeneous network. A heterogeneous network may also include home eNBs (HeNBs), which may provide service to a restricted group known as a closed subscriber group (CSG).

The communication links 120 between the base stations 102 and the UEs 104 may include uplink (also referred to as reverse link) transmissions from a UE 104 to a base station 102 and/or downlink (DL) (also referred to as forward link) transmissions from a base station 102 to a UE 104. The communication links 120 may use MIMO antenna technology, including spatial multiplexing, beamforming, and/or transmit diversity. The communication links 120 may be through one or more carrier frequencies. Allocation of carriers may be asymmetric with respect to downlink and uplink (e.g., more or less carriers may be allocated for downlink than for uplink).

The wireless communications system 100 may further include a wireless local area network (WLAN) access point (AP) 150 in communication with WLAN stations (STAs) 152 via communication links 154 in an unlicensed frequency spectrum (e.g., 5 GHz). When communicating in an unlicensed frequency spectrum, the WLAN STAs 152 and/or the WLAN AP 150 may perform a clear channel assessment (CCA) or listen before talk (LBT) procedure prior to communicating in order to determine whether the channel is available.

The small cell base station 102′ may operate in a licensed and/or an unlicensed frequency spectrum. When operating in an unlicensed frequency spectrum, the small cell base station 102′ may employ LTE or NR technology and use the same 5 GHz unlicensed frequency spectrum as used by the WLAN AP 150. The small cell base station 102′, employing LTE/5G in an unlicensed frequency spectrum, may boost coverage to and/or increase capacity of the access network. NR in unlicensed spectrum may be referred to as NR-U. LTE in an unlicensed spectrum may be referred to as LTE-U, licensed assisted access (LAA), or MulteFire.

The wireless communications system 100 may further include a mmW base station 180 that may operate in millimeter wave (mmW) frequencies and/or near mmW frequencies in communication with a UE 182. Extremely high frequency (EHF) is part of the RF in the electromagnetic spectrum. EHF has a range of 30 GHz to 300 GHz and a wavelength between 1 millimeter and 10 millimeters. Radio waves in this band may be referred to as a millimeter wave. Near mmW may extend down to a frequency of 3 GHz with a wavelength of 100 millimeters. The super high frequency (SHF) band extends between 3 GHz and 30 GHz, also referred to as centimeter wave. Communications using the mmW/near mmW radio frequency band have high path loss and a relatively short range. The mmW base station 180 and the UE 182 may utilize beamforming (transmit and/or receive) over a mmW communication link 184 to compensate for the extremely high path loss and short range. Further, it will be appreciated that in alternative configurations, one or more base stations 102 may also transmit using mm W or near mm W and beamforming. Accordingly, it will be appreciated that the foregoing illustrations are merely examples and should not be construed to limit the various aspects disclosed herein.

Transmit beamforming is a technique for focusing an RF signal in a specific direction. Traditionally, when a network node (e.g., a base station) broadcasts an RF signal, it broadcasts the signal in all directions (omni-directionally). With transmit beamforming, the network node determines where a given target device (e.g., a UE) is located (relative to the transmitting network node) and projects a stronger downlink RF signal in that specific direction, thereby providing a faster (in terms of data rate) and stronger RF signal for the receiving device(s). To change the directionality of the RF signal when transmitting, a network node can control the phase and relative amplitude of the RF signal at each of the one or more transmitters that are broadcasting the RF signal. For example, a network node may use an array of antennas (referred to as a “phased array” or an “antenna array”) that creates a beam of RF waves that can be “steered” to point in different directions, without actually moving the antennas. Specifically, the RF current from the transmitter is fed to the individual antennas with the correct phase relationship so that the radio waves from the separate antennas add together to increase the radiation in a desired direction, while cancelling to suppress radiation in undesired directions.

Transmit beams may be quasi-co-located, meaning that they appear to the receiver (e.g., a UE) as having the same parameters, regardless of whether or not the transmitting antennas of the network node themselves are physically co-located. In NR, there are four types of quasi-co-location (QCL) relations. Specifically, a QCL relation of a given type means that certain parameters about a second reference RF signal on a second beam can be derived from information about a source reference RF signal on a source beam. Thus, if the source reference RF signal is QCL Type A, the receiver can use the source reference RF signal to estimate the Doppler shift, Doppler spread, average delay, and delay spread of a second reference RF signal transmitted on the same channel. If the source reference RF signal is QCL Type B, the receiver can use the source reference RF signal to estimate the Doppler shift and Doppler spread of a second reference RF signal transmitted on the same channel. If the source reference RF signal is QCL Type C, the receiver can use the source reference RF signal to estimate the Doppler shift and average delay of a second reference RF signal transmitted on the same channel. If the source reference RF signal is QCL Type D, the receiver can use the source reference RF signal to estimate the spatial receive parameter of a second reference RF signal transmitted on the same channel.

In receive beamforming, the receiver uses a receive beam to amplify RF signals detected on a given channel. For example, the receiver can increase the gain setting and/or adjust the phase setting of an array of antennas in a particular direction to amplify (e.g., to increase the gain level of) the RF signals received from that direction. Thus, when a receiver is said to beamform in a certain direction, it means the beam gain in that direction is high relative to the beam gain along other directions, or the beam gain in that direction is the highest compared to the beam gain in that direction of all other receive beams available to the receiver. This results in a stronger received signal strength (e.g., reference signal received power (RSRP), reference signal received quality (RSRQ), signal-to-interference-plus-noise ratio (SINR), etc.) of the RF signals received from that direction.

Transmit and receive beams may be spatially related. A spatial relation means that parameters for a second beam (e.g., a transmit or receive beam) for a second reference signal can be derived from information about a first beam (e.g., a receive beam or a transmit beam) for a first reference signal. For example, a UE may use a particular receive beam to receive a reference downlink reference signal (e.g., synchronization signal block (SSB)) from a base station. The UE can then form a transmit beam for sending an uplink reference signal (e.g., sounding reference signal (SRS)) to that base station based on the parameters of the receive beam.

Note that a “downlink” beam may be either a transmit beam or a receive beam, depending on the entity forming it. For example, if a base station is forming the downlink beam to transmit a reference signal to a UE, the downlink beam is a transmit beam. If the UE is forming the downlink beam, however, it is a receive beam to receive the downlink reference signal. Similarly, an “uplink” beam may be either a transmit beam or a receive beam, depending on the entity forming it. For example, if a base station is forming the uplink beam, it is an uplink receive beam, and if a UE is forming the uplink beam, it is an uplink transmit beam.

The electromagnetic spectrum is often subdivided, based on frequency/wavelength, into various classes, bands, channels, etc. In 5G NR two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

In a multi-carrier system, such as 5G, one of the carrier frequencies is referred to as the “primary carrier” or “anchor carrier” or “primary serving cell” or “PCell,” and the remaining carrier frequencies are referred to as “secondary carriers” or “secondary serving cells” or “SCells.” In carrier aggregation, the anchor carrier is the carrier operating on the primary frequency (e.g., FR1) utilized by a UE 104/182 and the cell in which the UE 104/182 either performs the initial radio resource control (RRC) connection establishment procedure or initiates the RRC connection re-establishment procedure. The primary carrier carries all common and UE-specific control channels, and may be a carrier in a licensed frequency (however, this is not always the case). A secondary carrier is a carrier operating on a second frequency (e.g., FR2) that may be configured once the RRC connection is established between the UE 104 and the anchor carrier and that may be used to provide additional radio resources. In some cases, the secondary carrier may be a carrier in an unlicensed frequency. The secondary carrier may contain only necessary signaling information and signals, for example, those that are UE-specific may not be present in the secondary carrier, since both primary uplink and downlink carriers are typically UE-specific. This means that different UEs 104/182 in a cell may have different downlink primary carriers. The same is true for the uplink primary carriers. The network is able to change the primary carrier of any UE 104/182 at any time. This is done, for example, to balance the load on different carriers. Because a “serving cell” (whether a PCell or an SCell) corresponds to a carrier frequency/component carrier over which some base station is communicating, the term “cell,” “serving cell,” “component carrier,” “carrier frequency,” and the like can be used interchangeably.

For example, still referring to FIG. 1, one of the frequencies utilized by the macro cell base stations 102 may be an anchor carrier (or “PCell”) and other frequencies utilized by the macro cell base stations 102 and/or the mmW base station 180 may be secondary carriers (“SCells”). The simultaneous transmission and/or reception of multiple carriers enables the UE 104/182 to significantly increase its data transmission and/or reception rates. For example, two 20 MHz aggregated carriers in a multi-carrier system would theoretically lead to a two-fold increase in data rate (i.e., 40 MHz), compared to that attained by a single 20 MHz carrier.

In the example of FIG. 1, any of the illustrated UEs (shown in FIG. 1 as a single UE 104 for simplicity) may receive signals 124 from one or more Earth orbiting space vehicles (SVs) 112 (e.g., satellites). In an aspect, the SVs 112 may be part of a satellite positioning system that a UE 104 can use as an independent source of location information. A satellite positioning system typically includes a system of transmitters (e.g., SVs 112) positioned to enable receivers (e.g., UEs 104) to determine their location on or above the Earth based, at least in part, on positioning signals (e.g., signals 124) received from the transmitters. Such a transmitter typically transmits a signal marked with a repeating pseudo-random noise (PN) code of a set number of chips. While typically located in SVs 112, transmitters may sometimes be located on ground-based control stations, base stations 102, and/or other UEs 104. A UE 104 may include one or more dedicated receivers specifically designed to receive signals 124 for deriving geo location information from the SVs 112.

In a satellite positioning system, the use of signals 124 can be augmented by various satellite-based augmentation systems (SBAS) that may be associated with or otherwise enabled for use with one or more global and/or regional navigation satellite systems. For example an SBAS may include an augmentation system(s) that provides integrity information, differential corrections, etc., such as the Wide Area Augmentation System (WAAS), the European Geostationary Navigation Overlay Service (EGNOS), the Multi-functional Satellite Augmentation System (MSAS), the Global Positioning System (GPS) Aided Geo Augmented Navigation or GPS and Geo Augmented Navigation system (GAGAN), and/or the like. Thus, as used herein, a satellite positioning system may include any combination of one or more global and/or regional navigation satellites associated with such one or more satellite positioning systems.

In an aspect, SVs 112 may additionally or alternatively be part of one or more non-terrestrial networks (NTNs). In an NTN, an SV 112 is connected to an earth station (also referred to as a ground station, NTN gateway, or gateway), which in turn is connected to an element in a 5G network, such as a modified base station 102 (without a terrestrial antenna) or a network node in a 5GC. This element would in turn provide access to other elements in the 5G network and ultimately to entities external to the 5G network, such as Internet web servers and other user devices. In that way, a UE 104 may receive communication signals (e.g., signals 124) from an SV 112 instead of, or in addition to, communication signals from a terrestrial base station 102.

Leveraging the increased data rates and decreased latency of NR, among other things, vehicle-to-everything (V2X) communication technologies are being implemented to support intelligent transportation systems (ITS) applications, such as wireless communications between vehicles (vehicle-to-vehicle (V2V)), between vehicles and the roadside infrastructure (vehicle-to-infrastructure (V2I)), and between vehicles and pedestrians (vehicle-to-pedestrian (V2P)). The goal is for vehicles to be able to sense the environment around them and communicate that information to other vehicles, infrastructure, and personal mobile devices. Such vehicle communication will enable safety, mobility, and environmental advancements that current technologies are unable to provide. Once fully implemented, the technology is expected to reduce unimpaired vehicle crashes by 80%.

Still referring to FIG. 1, the wireless communications system 100 may include multiple V-UEs 160 that may communicate with base stations 102 over communication links 120 using the Uu interface (i.e., the air interface between a UE and a base station). V-UEs 160 may also communicate directly with each other over a wireless sidelink 162, with a roadside unit (RSU) 164 (a roadside access point) over a wireless sidelink 166, or with sidelink-capable UEs 104 over a wireless sidelink 168 using the PC5 interface (i.e., the air interface between sidelink-capable UEs). A wireless sidelink (or just “sidelink”) is an adaptation of the core cellular (e.g., LTE, NR) standard that allows direct communication between two or more UEs without the communication needing to go through a base station. Sidelink communication may be unicast or multicast, and may be used for device-to-device (D2D) media-sharing, V2V communication, V2X communication (e.g., cellular V2X (cV2X) communication, enhanced V2X (eV2X) communication, etc.), emergency rescue applications, etc. One or more of a group of V-UEs 160 utilizing sidelink communications may be within the geographic coverage area 110 of a base station 102. Other V-UEs 160 in such a group may be outside the geographic coverage area 110 of a base station 102 or be otherwise unable to receive transmissions from a base station 102. In some cases, groups of V-UEs 160 communicating via sidelink communications may utilize a one-to-many (1:M) system in which each V-UE 160 transmits to every other V-UE 160 in the group. In some cases, a base station 102 facilitates the scheduling of resources for sidelink communications. In other cases, sidelink communications are carried out between V-UEs 160 without the involvement of a base station 102.

In an aspect, the sidelinks 162, 166, 168 may operate over a wireless communication medium of interest, which may be shared with other wireless communications between other vehicles and/or infrastructure access points, as well as other RATs. A “medium” may be composed of one or more time, frequency, and/or space communication resources (e.g., encompassing one or more channels across one or more carriers) associated with wireless communication between one or more transmitter/receiver pairs.

In an aspect, the sidelinks 162, 166, 168 may be cV2X links. A first generation of cV2X has been standardized in LTE, and the next generation is expected to be defined in NR. cV2X is a cellular technology that also enables device-to-device communications. In the U.S. and Europe, cV2X is expected to operate in the licensed ITS band in sub-6 GHZ. Other bands may be allocated in other countries. Thus, as a particular example, the medium of interest utilized by sidelinks 162, 166, 168 may correspond to at least a portion of the licensed ITS frequency band of sub-6 GHZ. However, the present disclosure is not limited to this frequency band or cellular technology.

In an aspect, the sidelinks 162, 166, 168 may be dedicated short-range communications (DSRC) links. DSRC is a one-way or two-way short-range to medium-range wireless communication protocol that uses the wireless access for vehicular environments (WAVE) protocol, also known as IEEE 802.11p, for V2V, V2I, and V2P communications. IEEE 802.11p is an approved amendment to the IEEE 802.11 standard and operates in the licensed ITS band of 5.9 GHz (5.85-5.925 GHz) in the U.S. In Europe, IEEE 802.11p operates in the ITS G5A band (5.875-5.905 MHz). Other bands may be allocated in other countries. The V2V communications briefly described above occur on the Safety Channel, which in the U.S. is typically a 10 MHz channel that is dedicated to the purpose of safety. The remainder of the DSRC band (the total bandwidth is 75 MHz) is intended for other services of interest to drivers, such as road rules, tolling, parking automation, etc. Thus, as a particular example, the mediums of interest utilized by sidelinks 162, 166, 168 may correspond to at least a portion of the licensed ITS frequency band of 5.9 GHz.

Alternatively, the medium of interest may correspond to at least a portion of an unlicensed frequency band shared among various RATs. Although different licensed frequency bands have been reserved for certain communication systems (e.g., by a government entity such as the Federal Communications Commission (FCC) in the United States), these systems, in particular those employing small cell access points, have recently extended operation into unlicensed frequency bands such as the Unlicensed National Information Infrastructure (U-NII) band used by wireless local area network (WLAN) technologies, most notably IEEE 802.11x WLAN technologies generally referred to as “Wi-Fi.” Example systems of this type include different variants of CDMA systems, TDMA systems, FDMA systems, orthogonal FDMA (OFDMA) systems, single-carrier FDMA (SC-FDMA) systems, and so on.

Communications between the V-UEs 160 are referred to as V2V communications, communications between the V-UEs 160 and the one or more RSUs 164 are referred to as V2I communications, and communications between the V-UEs 160 and one or more UEs 104 (where the UEs 104 are P-UEs) are referred to as V2P communications. The V2V communications between V-UEs 160 may include, for example, information about the position, speed, acceleration, heading, and other vehicle data of the V-UEs 160. The V2I information received at a V-UE 160 from the one or more RSUs 164 may include, for example, road rules, parking automation information, etc. The V2P communications between a V-UE 160 and a UE 104 may include information about, for example, the position, speed, acceleration, and heading of the V-UE 160 and the position, speed (e.g., where the UE 104 is carried by a user on a bicycle), and heading of the UE 104.

Note that although FIG. 1 only illustrates two of the UEs as V-UEs (V-UEs 160), any of the illustrated UEs (e.g., UEs 104, 152, 182, 190) may be V-UEs. In addition, while only the V-UEs 160 and a single UE 104 have been illustrated as being connected over a sidelink, any of the UEs illustrated in FIG. 1, whether V-UEs, P-UEs, etc., may be capable of sidelink communication. Further, although only UE 182 was described as being capable of beam forming, any of the illustrated UEs, including V-UEs 160, may be capable of beam forming. Where V-UEs 160 are capable of beam forming, they may beam form towards each other (i.e., towards other V-UEs 160), towards RSUs 164, towards other UEs (e.g., UEs 104, 152, 182, 190), etc. Thus, in some cases, V-UEs 160 may utilize beamforming over sidelinks 162, 166, and 168.

The wireless communications system 100 may further include one or more UEs, such as UE 190, that connects indirectly to one or more communication networks via one or more device-to-device (D2D) peer-to-peer (P2P) links. In the example of FIG. 1, UE 190 has a D2D P2P link 192 with one of the UEs 104 connected to one of the base stations 102 (e.g., through which UE 190 may indirectly obtain cellular connectivity) and a D2D P2P link 194 with WLAN STA 152 connected to the WLAN AP 150 (through which UE 190 may indirectly obtain WLAN-based Internet connectivity). In an example, the D2D P2P links 192 and 194 may be supported with any well-known D2D RAT, such as LTE Direct (LTE-D), WiFi Direct (WiFi-D), Bluetooth®, and so on. As another example, the D2D P2P links 192 and 194 may be sidelinks, as described above with reference to sidelinks 162, 166, and 168.

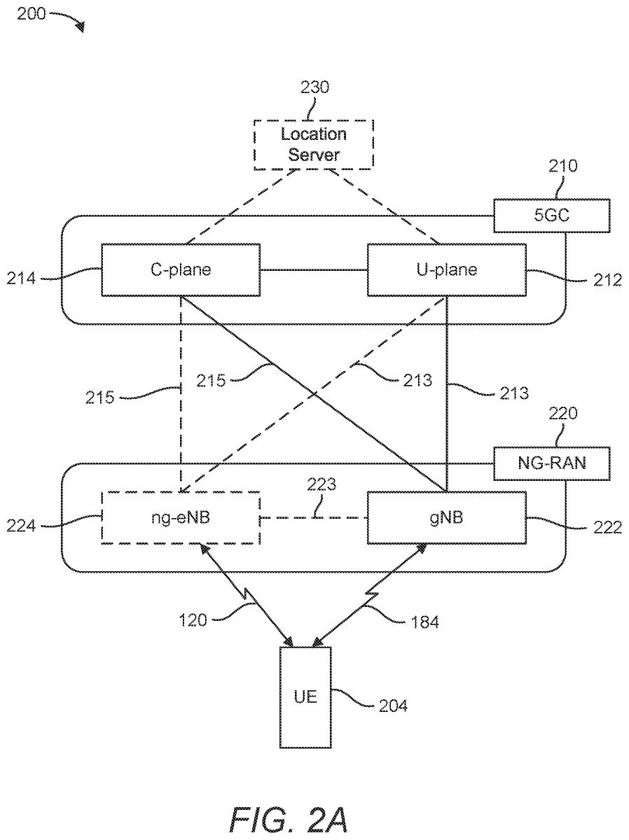

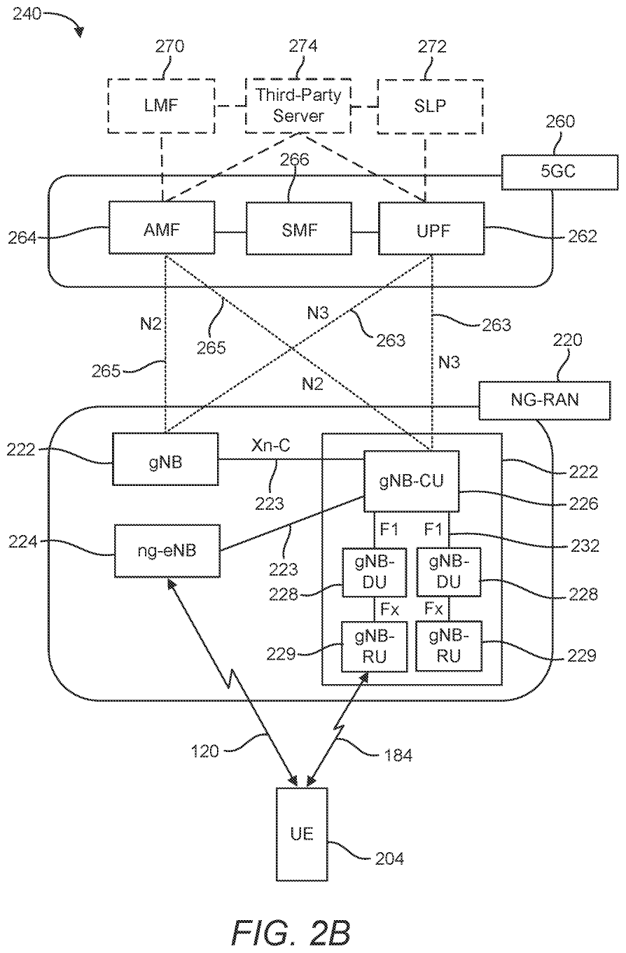

FIG. 2A illustrates an example wireless network structure 200. For example, a 5GC 210 (also referred to as a Next Generation Core (NGC)) can be viewed functionally as control plane (C-plane) functions 214 (e.g., UE registration, authentication, network access, gateway selection, etc.) and user plane (U-plane) functions 212, (e.g., UE gateway function, access to data networks, IP routing, etc.) which operate cooperatively to form the core network. User plane interface (NG-U) 213 and control plane interface (NG-C) 215 connect the gNB 222 to the 5GC 210 and specifically to the user plane functions 212 and control plane functions 214, respectively. In an additional configuration, an ng-eNB 224 may also be connected to the 5GC 210 via NG-C 215 to the control plane functions 214 and NG-U 213 to user plane functions 212. Further, ng-eNB 224 may directly communicate with gNB 222 via a backhaul connection 223. In some configurations, a Next Generation RAN (NG-RAN) 220 may have one or more gNBs 222, while other configurations include one or more of both ng-eNBs 224 and gNBs 222. Either (or both) gNB 222 or ng-eNB 224 may communicate with one or more UEs 204 (e.g., any of the UEs described herein).

Another optional aspect may include a location server 230, which may be in communication with the 5GC 210 to provide location assistance for UE(s) 204. The location server 230 can be implemented as a plurality of separate servers (e.g., physically separate servers, different software modules on a single server, different software modules spread across multiple physical servers, etc.), or alternately may each correspond to a single server. The location server 230 can be configured to support one or more location services for UEs 204 that can connect to the location server 230 via the core network, 5GC 210, and/or via the Internet (not illustrated). Further, the location server 230 may be integrated into a component of the core network, or alternatively may be external to the core network (e.g., a third party server, such as an original equipment manufacturer (OEM) server or service server).

FIG. 2B illustrates another example wireless network structure 240. A 5GC 260 (which may correspond to 5GC 210 in FIG. 2A) can be viewed functionally as control plane functions, provided by an access and mobility management function (AMF) 264, and user plane functions, provided by a user plane function (UPF) 262, which operate cooperatively to form the core network (i.e., 5GC 260). The functions of the AMF 264 include registration management, connection management, reachability management, mobility management, lawful interception, transport for session management (SM) messages between one or more UEs 204 (e.g., any of the UEs described herein) and a session management function (SMF) 266, transparent proxy services for routing SM messages, access authentication and access authorization, transport for short message service (SMS) messages between the UE 204 and the short message service function (SMSF) (not shown), and security anchor functionality (SEAF). The AMF 264 also interacts with an authentication server function (AUSF) (not shown) and the UE 204, and receives the intermediate key that was established as a result of the UE 204 authentication process. In the case of authentication based on a UMTS (universal mobile telecommunications system) subscriber identity module (USIM), the AMF 264 retrieves the security material from the AUSF. The functions of the AMF 264 also include security context management (SCM). The SCM receives a key from the SEAF that it uses to derive access-network specific keys. The functionality of the AMF 264 also includes location services management for regulatory services, transport for location services messages between the UE 204 and a location management function (LMF) 270 (which acts as a location server 230), transport for location services messages between the NG-RAN 220 and the LMF 270, evolved packet system (EPS) bearer identifier allocation for interworking with the EPS, and UE 204 mobility event notification. In addition, the AMF 264 also supports functionalities for non-3GPP (Third Generation Partnership Project) access networks.

Functions of the UPF 262 include acting as an anchor point for intra-/inter-RAT mobility (when applicable), acting as an external protocol data unit (PDU) session point of interconnect to a data network (not shown), providing packet routing and forwarding, packet inspection, user plane policy rule enforcement (e.g., gating, redirection, traffic steering), lawful interception (user plane collection), traffic usage reporting, quality of service (QoS) handling for the user plane (e.g., uplink/downlink rate enforcement, reflective QoS marking in the downlink), uplink traffic verification (service data flow (SDF) to QoS flow mapping), transport level packet marking in the uplink and downlink, downlink packet buffering and downlink data notification triggering, and sending and forwarding of one or more “end markers” to the source RAN node. The UPF 262 may also support transfer of location services messages over a user plane between the UE 204 and a location server, such as an SLP 272.

The functions of the SMF 266 include session management, UE Internet protocol (IP) address allocation and management, selection and control of user plane functions, configuration of traffic steering at the UPF 262 to route traffic to the proper destination, control of part of policy enforcement and QoS, and downlink data notification. The interface over which the SMF 266 communicates with the AMF 264 is referred to as the N11 interface.

Another optional aspect may include an LMF 270, which may be in communication with the 5GC 260 to provide location assistance for UEs 204. The LMF 270 can be implemented as a plurality of separate servers (e.g., physically separate servers, different software modules on a single server, different software modules spread across multiple physical servers, etc.), or alternately may each correspond to a single server. The LMF 270 can be configured to support one or more location services for UEs 204 that can connect to the LMF 270 via the core network, 5GC 260, and/or via the Internet (not illustrated). The SLP 272 may support similar functions to the LMF 270, but whereas the LMF 270 may communicate with the AMF 264, NG-RAN 220, and UEs 204 over a control plane (e.g., using interfaces and protocols intended to convey signaling messages and not voice or data), the SLP 272 may communicate with UEs 204 and external clients (e.g., third-party server 274) over a user plane (e.g., using protocols intended to carry voice and/or data like the transmission control protocol (TCP) and/or IP).

Yet another optional aspect may include a third-party server 274, which may be in communication with the LMF 270, the SLP 272, the 5GC 260 (e.g., via the AMF 264 and/or the UPF 262), the NG-RAN 220, and/or the UE 204 to obtain location information (e.g., a location estimate) for the UE 204. As such, in some cases, the third-party server 274 may be referred to as a location services (LCS) client or an external client. The third-party server 274 can be implemented as a plurality of separate servers (e.g., physically separate servers, different software modules on a single server, different software modules spread across multiple physical servers, etc.), or alternately may each correspond to a single server.

User plane interface 263 and control plane interface 265 connect the 5GC 260, and specifically the UPF 262 and AMF 264, respectively, to one or more gNBs 222 and/or ng-eNBs 224 in the NG-RAN 220. The interface between gNB(s) 222 and/or ng-eNB(s) 224 and the AMF 264 is referred to as the “N2” interface, and the interface between gNB(s) 222 and/or ng-eNB(s) 224 and the UPF 262 is referred to as the “N3” interface. The gNB(s) 222 and/or ng-eNB(s) 224 of the NG-RAN 220 may communicate directly with each other via backhaul connections 223, referred to as the “Xn-C” interface. One or more of gNBs 222 and/or ng-eNBs 224 may communicate with one or more UEs 204 over a wireless interface, referred to as the “Uu” interface.

The functionality of a gNB 222 may be divided between a gNB central unit (gNB-CU) 226, one or more gNB distributed units (gNB-DUs) 228, and one or more gNB radio units (gNB-RUs) 229. A gNB-CU 226 is a logical node that includes the base station functions of transferring user data, mobility control, radio access network sharing, positioning, session management, and the like, except for those functions allocated exclusively to the gNB-DU(s) 228. More specifically, the gNB-CU 226 generally host the radio resource control (RRC), service data adaptation protocol (SDAP), and packet data convergence protocol (PDCP) protocols of the gNB 222. A gNB-DU 228 is a logical node that generally hosts the radio link control (RLC) and medium access control (MAC) layer of the gNB 222. Its operation is controlled by the gNB-CU 226. One gNB-DU 228 can support one or more cells, and one cell is supported by only one gNB-DU 228. The interface 232 between the gNB-CU 226 and the one or more gNB-DUs 228 is referred to as the “F1” interface. The physical (PHY) layer functionality of a gNB 222 is generally hosted by one or more standalone gNB-RUs 229 that perform functions such as power amplification and signal transmission/reception. The interface between a gNB-DU 228 and a gNB-RU 229 is referred to as the “Fx” interface. Thus, a UE 204 communicates with the gNB-CU 226 via the RRC, SDAP, and PDCP layers, with a gNB-DU 228 via the RLC and MAC layers, and with a gNB-RU 229 via the PHY layer.

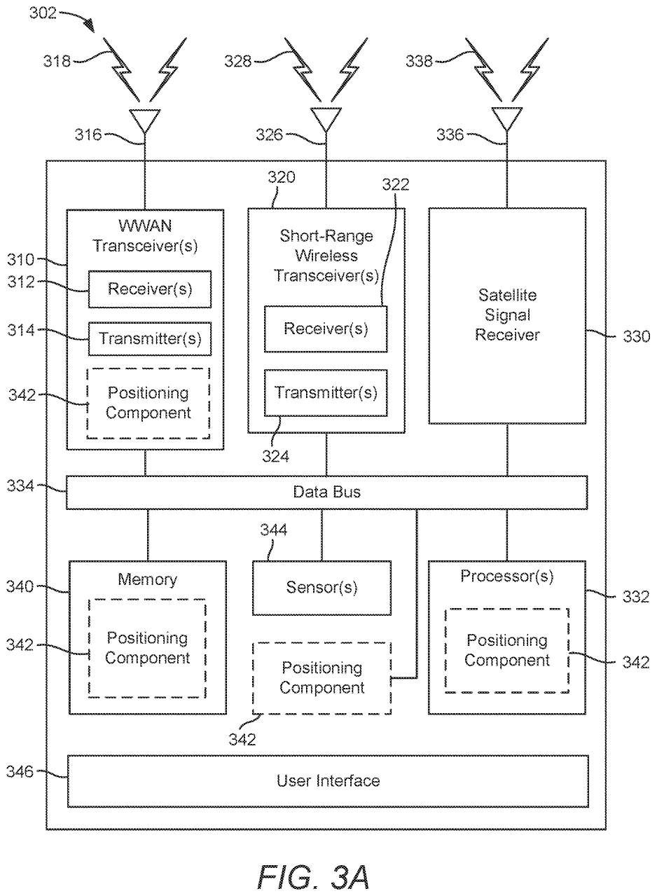

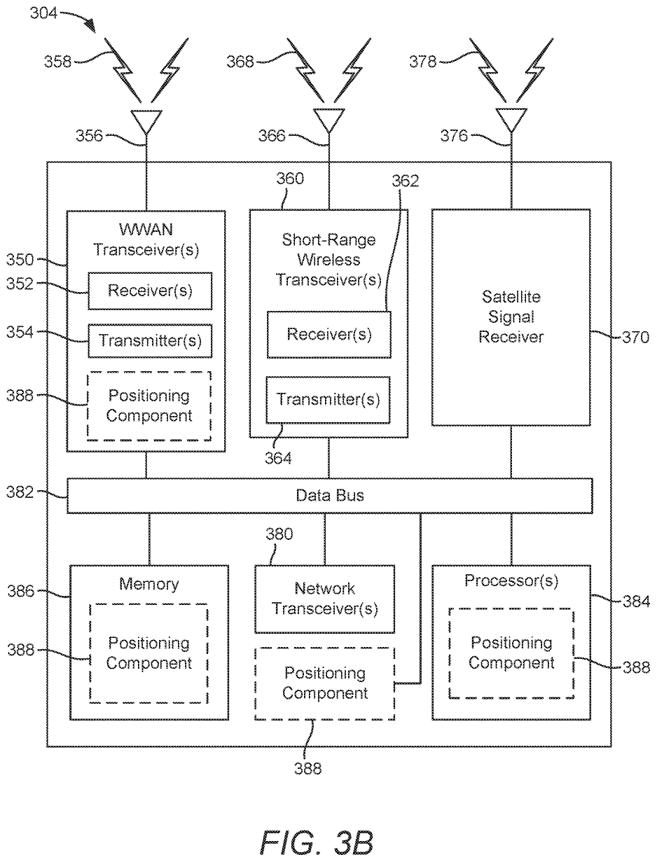

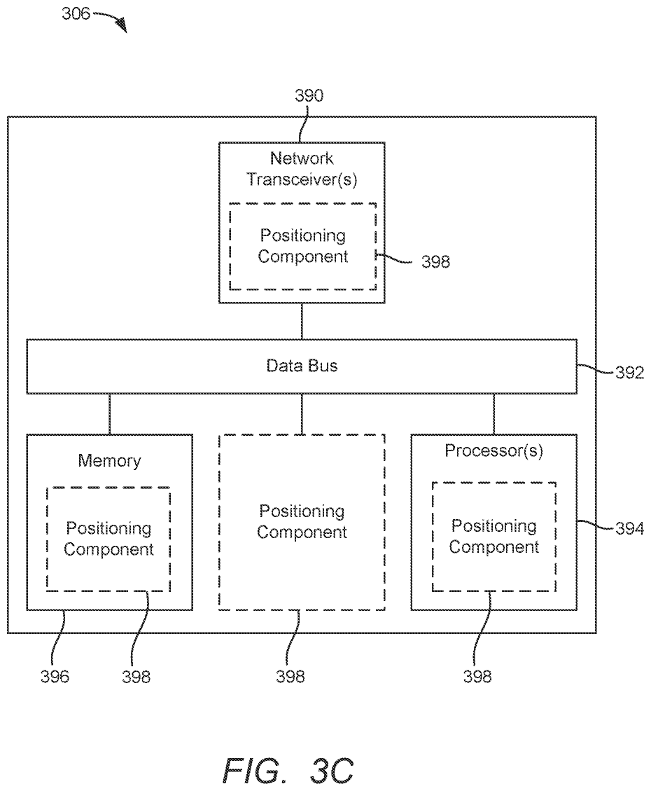

FIGS. 3A, 3B, and 3C illustrate several example components (represented by corresponding blocks) that may be incorporated into a UE 302 (which may correspond to any of the UEs described herein), a base station 304 (which may correspond to any of the base stations described herein), and a network entity 306 (which may correspond to or embody any of the network functions described herein, including the location server 230 and the LMF 270, or alternatively may be independent from the NG-RAN 220 and/or 5GC 210/260 infrastructure depicted in FIGS. 2A and 2B, such as a private network) to support the operations described herein. It will be appreciated that these components may be implemented in different types of apparatuses in different implementations (e.g., in an ASIC, in a system-on-chip (SoC), etc.). The illustrated components may also be incorporated into other apparatuses in a communication system. For example, other apparatuses in a system may include components similar to those described to provide similar functionality. Also, a given apparatus may contain one or more of the components. For example, an apparatus may include multiple transceiver components that enable the apparatus to operate on multiple carriers and/or communicate via different technologies.

The UE 302 and the base station 304 each include one or more wireless wide area network (WWAN) transceivers 310 and 350, respectively, providing means for communicating (e.g., means for transmitting, means for receiving, means for measuring, means for tuning, means for refraining from transmitting, etc.) via one or more wireless communication networks (not shown), such as an NR network, an LTE network, a GSM network, and/or the like. The WWAN transceivers 310 and 350 may each be connected to one or more antennas 316 and 356, respectively, for communicating with other network nodes, such as other UEs, access points, base stations (e.g., eNBs, gNBs), etc., via at least one designated RAT (e.g., NR, LTE, GSM, etc.) over a wireless communication medium of interest (e.g., some set of time/frequency resources in a particular frequency spectrum). The WWAN transceivers 310 and 350 may be variously configured for transmitting and encoding signals 318 and 358 (e.g., messages, indications, information, and so on), respectively, and, conversely, for receiving and decoding signals 318 and 358 (e.g., messages, indications, information, pilots, and so on), respectively, in accordance with the designated RAT. Specifically, the WWAN transceivers 310 and 350 include one or more transmitters 314 and 354, respectively, for transmitting and encoding signals 318 and 358, respectively, and one or more receivers 312 and 352, respectively, for receiving and decoding signals 318 and 358, respectively.

The UE 302 and the base station 304 each also include, at least in some cases, one or more short-range wireless transceivers 320 and 360, respectively. The short-range wireless transceivers 320 and 360 may be connected to one or more antennas 326 and 366, respectively, and provide means for communicating (e.g., means for transmitting, means for receiving, means for measuring, means for tuning, means for refraining from transmitting, etc.) with other network nodes, such as other UEs, access points, base stations, etc., via at least one designated RAT (e.g., WiFi, LTE-D, Bluetooth®, Zigbee®, Z-Wave®, PC5, dedicated short-range communications (DSRC), wireless access for vehicular environments (WAVE), near-field communication (NFC), ultra-wideband (UWB), etc.) over a wireless communication medium of interest. The short-range wireless transceivers 320 and 360 may be variously configured for transmitting and encoding signals 328 and 368 (e.g., messages, indications, information, and so on), respectively, and, conversely, for receiving and decoding signals 328 and 368 (e.g., messages, indications, information, pilots, and so on), respectively, in accordance with the designated RAT. Specifically, the short-range wireless transceivers 320 and 360 include one or more transmitters 324 and 364, respectively, for transmitting and encoding signals 328 and 368, respectively, and one or more receivers 322 and 362, respectively, for receiving and decoding signals 328 and 368, respectively. As specific examples, the short-range wireless transceivers 320 and 360 may be WiFi transceivers, Bluetooth® transceivers, Zigbee® and/or Z-Wave® transceivers, NFC transceivers, UWB transceivers, or vehicle-to-vehicle (V2V) and/or vehicle-to-everything (V2X) transceivers.

The UE 302 and the base station 304 also include, at least in some cases, satellite signal receivers 330 and 370. The satellite signal receivers 330 and 370 may be connected to one or more antennas 336 and 376, respectively, and may provide means for receiving and/or measuring satellite positioning/communication signals 338 and 378, respectively. Where the satellite signal receivers 330 and 370 are satellite positioning system receivers, the satellite positioning/communication signals 338 and 378 may be global positioning system (GPS) signals, global navigation satellite system (GLONASS) signals, Galileo signals, Beidou signals, Indian Regional Navigation Satellite System (NAVIC), Quasi-Zenith Satellite System (QZSS), etc. Where the satellite signal receivers 330 and 370 are non-terrestrial network (NTN) receivers, the satellite positioning/communication signals 338 and 378 may be communication signals (e.g., carrying control and/or user data) originating from a 5G network. The satellite signal receivers 330 and 370 may comprise any suitable hardware and/or software for receiving and processing satellite positioning/communication signals 338 and 378, respectively. The satellite signal receivers 330 and 370 may request information and operations as appropriate from the other systems, and, at least in some cases, perform calculations to determine locations of the UE 302 and the base station 304, respectively, using measurements obtained by any suitable satellite positioning system algorithm.

The base station 304 and the network entity 306 each include one or more network transceivers 380 and 390, respectively, providing means for communicating (e.g., means for transmitting, means for receiving, etc.) with other network entities (e.g., other base stations 304, other network entities 306). For example, the base station 304 may employ the one or more network transceivers 380 to communicate with other base stations 304 or network entities 306 over one or more wired or wireless backhaul links. As another example, the network entity 306 may employ the one or more network transceivers 390 to communicate with one or more base station 304 over one or more wired or wireless backhaul links, or with other network entities 306 over one or more wired or wireless core network interfaces.

A transceiver may be configured to communicate over a wired or wireless link. A transceiver (whether a wired transceiver or a wireless transceiver) includes transmitter circuitry (e.g., transmitters 314, 324, 354, 364) and receiver circuitry (e.g., receivers 312, 322, 352, 362). A transceiver may be an integrated device (e.g., embodying transmitter circuitry and receiver circuitry in a single device) in some implementations, may comprise separate transmitter circuitry and separate receiver circuitry in some implementations, or may be embodied in other ways in other implementations. The transmitter circuitry and receiver circuitry of a wired transceiver (e.g., network transceivers 380 and 390 in some implementations) may be coupled to one or more wired network interface ports. Wireless transmitter circuitry (e.g., transmitters 314, 324, 354, 364) may include or be coupled to a plurality of antennas (e.g., antennas 316, 326, 356, 366), such as an antenna array, that permits the respective apparatus (e.g., UE 302, base station 304) to perform transmit “beamforming,” as described herein. Similarly, wireless receiver circuitry (e.g., receivers 312, 322, 352, 362) may include or be coupled to a plurality of antennas (e.g., antennas 316, 326, 356, 366), such as an antenna array, that permits the respective apparatus (e.g., UE 302, base station 304) to perform receive beamforming, as described herein. In an aspect, the transmitter circuitry and receiver circuitry may share the same plurality of antennas (e.g., antennas 316, 326, 356, 366), such that the respective apparatus can only receive or transmit at a given time, not both at the same time. A wireless transceiver (e.g., WWAN transceivers 310 and 350, short-range wireless transceivers 320 and 360) may also include a network listen module (NLM) or the like for performing various measurements.

As used herein, the various wireless transceivers (e.g., transceivers 310, 320, 350, and 360, and network transceivers 380 and 390 in some implementations) and wired transceivers (e.g., network transceivers 380 and 390 in some implementations) may generally be characterized as “a transceiver,” “at least one transceiver,” or “one or more transceivers.” As such, whether a particular transceiver is a wired or wireless transceiver may be inferred from the type of communication performed. For example, backhaul communication between network devices or servers will generally relate to signaling via a wired transceiver, whereas wireless communication between a UE (e.g., UE 302) and a base station (e.g., base station 304) will generally relate to signaling via a wireless transceiver.

The UE 302, the base station 304, and the network entity 306 also include other components that may be used in conjunction with the operations as disclosed herein. The UE 302, the base station 304, and the network entity 306 include one or more processors 332, 384, and 394, respectively, for providing functionality relating to, for example, wireless communication, and for providing other processing functionality. The processors 332, 384, and 394 may therefore provide means for processing, such as means for determining, means for calculating, means for receiving, means for transmitting, means for indicating, etc. In an aspect, the processors 332, 384, and 394 may include, for example, one or more general purpose processors, multi-core processors, central processing units (CPUs), ASICs, digital signal processors (DSPs), field programmable gate arrays (FPGAs), other programmable logic devices or processing circuitry, or various combinations thereof.

The UE 302, the base station 304, and the network entity 306 include memory circuitry implementing memories 340, 386, and 396 (e.g., each including a memory device), respectively, for maintaining information (e.g., information indicative of reserved resources, thresholds, parameters, and so on). The memories 340, 386, and 396 may therefore provide means for storing, means for retrieving, means for maintaining, etc. In some cases, the UE 302, the base station 304, and the network entity 306 may include positioning component 342, 388, and 398, respectively. The positioning component 342, 388, and 398 may be hardware circuits that are part of or coupled to the processors 332, 384, and 394, respectively, that, when executed, cause the UE 302, the base station 304, and the network entity 306 to perform the functionality described herein. In other aspects, the positioning component 342, 388, and 398 may be external to the processors 332, 384, and 394 (e.g., part of a modem processing system, integrated with another processing system, etc.). Alternatively, the positioning component 342, 388, and 398 may be memory modules stored in the memories 340, 386, and 396, respectively, that, when executed by the processors 332, 384, and 394 (or a modem processing system, another processing system, etc.), cause the UE 302, the base station 304, and the network entity 306 to perform the functionality described herein. FIG. 3A illustrates possible locations of the positioning component 342, which may be, for example, part of the one or more WWAN transceivers 310, the memory 340, the one or more processors 332, or any combination thereof, or may be a standalone component. FIG. 3B illustrates possible locations of the positioning component 388, which may be, for example, part of the one or more WWAN transceivers 350, the memory 386, the one or more processors 384, or any combination thereof, or may be a standalone component. FIG. 3C illustrates possible locations of the positioning component 398, which may be, for example, part of the one or more network transceivers 390, the memory 396, the one or more processors 394, or any combination thereof, or may be a standalone component.

The UE 302 may include one or more sensors 344 coupled to the one or more processors 332 to provide means for sensing or detecting movement and/or orientation information that is independent of motion data derived from signals received by the one or more WWAN transceivers 310, the one or more short-range wireless transceivers 320, and/or the satellite signal receiver 330. By way of example, the sensor(s) 344 may include an accelerometer (e.g., a micro-electrical mechanical systems (MEMS) device), a gyroscope, a geomagnetic sensor (e.g., a compass), an altimeter (e.g., a barometric pressure altimeter), and/or any other type of movement detection sensor. Moreover, the sensor(s) 344 may include a plurality of different types of devices and combine their outputs in order to provide motion information. For example, the sensor(s) 344 may use a combination of a multi-axis accelerometer and orientation sensors to provide the ability to compute positions in two-dimensional (2D) and/or three-dimensional (3D) coordinate systems.

In addition, the UE 302 includes a user interface 346 providing means for providing indications (e.g., audible and/or visual indications) to a user and/or for receiving user input (e.g., upon user actuation of a sensing device such a keypad, a touch screen, a microphone, and so on). Although not shown, the base station 304 and the network entity 306 may also include user interfaces.

Referring to the one or more processors 384 in more detail, in the downlink, IP packets from the network entity 306 may be provided to the processor 384. The one or more processors 384 may implement functionality for an RRC layer, a packet data convergence protocol (PDCP) layer, a radio link control (RLC) layer, and a medium access control (MAC) layer. The one or more processors 384 may provide RRC layer functionality associated with broadcasting of system information (e.g., master information block (MIB), system information blocks (SIBs)), RRC connection control (e.g., RRC connection paging, RRC connection establishment, RRC connection modification, and RRC connection release), inter-RAT mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer PDUs, error correction through automatic repeat request (ARQ), concatenation, segmentation, and reassembly of RLC service data units (SDUs), re-segmentation of RLC data PDUs, and reordering of RLC data PDUs; and MAC layer functionality associated with mapping between logical channels and transport channels, scheduling information reporting, error correction, priority handling, and logical channel prioritization.

The transmitter 354 and the receiver 352 may implement Layer-1 (L1) functionality associated with various signal processing functions. Layer-1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The transmitter 354 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an orthogonal frequency division multiplexing (OFDM) subcarrier, multiplexed with a reference signal (e.g., pilot) in the time and/or frequency domain, and then combined together using an inverse fast Fourier transform (IFFT) to produce a physical channel carrying a time domain OFDM symbol stream. The OFDM symbol stream is spatially precoded to produce multiple spatial streams. Channel estimates from a channel estimator may be used to determine the coding and modulation scheme, as well as for spatial processing. The channel estimate may be derived from a reference signal and/or channel condition feedback transmitted by the UE 302. Each spatial stream may then be provided to one or more different antennas 356. The transmitter 354 may modulate an RF carrier with a respective spatial stream for transmission.

At the UE 302, the receiver 312 receives a signal through its respective antenna(s) 316. The receiver 312 recovers information modulated onto an RF carrier and provides the information to the one or more processors 332. The transmitter 314 and the receiver 312 implement Layer-1 functionality associated with various signal processing functions. The receiver 312 may perform spatial processing on the information to recover any spatial streams destined for the UE 302. If multiple spatial streams are destined for the UE 302, they may be combined by the receiver 312 into a single OFDM symbol stream. The receiver 312 then converts the OFDM symbol stream from the time-domain to the frequency domain using a fast Fourier transform (FFT). The frequency domain signal comprises a separate OFDM symbol stream for each subcarrier of the OFDM signal. The symbols on each subcarrier, and the reference signal, are recovered and demodulated by determining the most likely signal constellation points transmitted by the base station 304. These soft decisions may be based on channel estimates computed by a channel estimator. The soft decisions are then decoded and de-interleaved to recover the data and control signals that were originally transmitted by the base station 304 on the physical channel. The data and control signals are then provided to the one or more processors 332, which implements Layer-3 (L3) and Layer-2 (L2) functionality.

In the downlink, the one or more processors 332 provides demultiplexing between transport and logical channels, packet reassembly, deciphering, header decompression, and control signal processing to recover IP packets from the core network. The one or more processors 332 are also responsible for error detection.

Similar to the functionality described in connection with the downlink transmission by the base station 304, the one or more processors 332 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through hybrid automatic repeat request (HARQ), priority handling, and logical channel prioritization.

Channel estimates derived by the channel estimator from a reference signal or feedback transmitted by the base station 304 may be used by the transmitter 314 to select the appropriate coding and modulation schemes, and to facilitate spatial processing. The spatial streams generated by the transmitter 314 may be provided to different antenna(s) 316. The transmitter 314 may modulate an RF carrier with a respective spatial stream for transmission.

The uplink transmission is processed at the base station 304 in a manner similar to that described in connection with the receiver function at the UE 302. The receiver 352 receives a signal through its respective antenna(s) 356. The receiver 352 recovers information modulated onto an RF carrier and provides the information to the one or more processors 384.

In the uplink, the one or more processors 384 provides demultiplexing between transport and logical channels, packet reassembly, deciphering, header decompression, control signal processing to recover IP packets from the UE 302. IP packets from the one or more processors 384 may be provided to the core network. The one or more processors 384 are also responsible for error detection.

For convenience, the UE 302, the base station 304, and/or the network entity 306 are shown in FIGS. 3A, 3B, and 3C as including various components that may be configured according to the various examples described herein. It will be appreciated, however, that the illustrated components may have different functionality in different designs. In particular, various components in FIGS. 3A to 3C are optional in alternative configurations and the various aspects include configurations that may vary due to design choice, costs, use of the device, or other considerations. For example, in case of FIG. 3A, a particular implementation of UE 302 may omit the WWAN transceiver(s) 310 (e.g., a wearable device or tablet computer or PC or laptop may have Wi-Fi and/or Bluetooth capability without cellular capability), or may omit the short-range wireless transceiver(s) 320 (e.g., cellular-only, etc.), or may omit the satellite signal receiver 330, or may omit the sensor(s) 344, and so on. In another example, in case of FIG. 3B, a particular implementation of the base station 304 may omit the WWAN transceiver(s) 350 (e.g., a Wi-Fi “hotspot” access point without cellular capability), or may omit the short-range wireless transceiver(s) 360 (e.g., cellular-only, etc.), or may omit the satellite signal receiver 370, and so on. For brevity, illustration of the various alternative configurations is not provided herein, but would be readily understandable to one skilled in the art.

The various components of the UE 302, the base station 304, and the network entity 306 may be communicatively coupled to each other over data buses 334, 382, and 392, respectively. In an aspect, the data buses 334, 382, and 392 may form, or be part of, a communication interface of the UE 302, the base station 304, and the network entity 306, respectively. For example, where different logical entities are embodied in the same device (e.g., gNB and location server functionality incorporated into the same base station 304), the data buses 334, 382, and 392 may provide communication between them.

The components of FIGS. 3A, 3B, and 3C may be implemented in various ways. In some implementations, the components of FIGS. 3A, 3B, and 3C may be implemented in one or more circuits such as, for example, one or more processors and/or one or more ASICs (which may include one or more processors). Here, each circuit may use and/or incorporate at least one memory component for storing information or executable code used by the circuit to provide this functionality. For example, some or all of the functionality represented by blocks 310 to 346 may be implemented by processor and memory component(s) of the UE 302 (e.g., by execution of appropriate code and/or by appropriate configuration of processor components). Similarly, some or all of the functionality represented by blocks 350 to 388 may be implemented by processor and memory component(s) of the base station 304 (e.g., by execution of appropriate code and/or by appropriate configuration of processor components). Also, some or all of the functionality represented by blocks 390 to 398 may be implemented by processor and memory component(s) of the network entity 306 (e.g., by execution of appropriate code and/or by appropriate configuration of processor components). For simplicity, various operations, acts, and/or functions are described herein as being performed “by a UE,” “by a base station,” “by a network entity,” etc. However, as will be appreciated, such operations, acts, and/or functions may actually be performed by specific components or combinations of components of the UE 302, base station 304, network entity 306, etc., such as the processors 332, 384, 394, the transceivers 310, 320, 350, and 360, the memories 340, 386, and 396, the positioning component 342, 388, and 398, etc.

In some designs, the network entity 306 may be implemented as a core network component. In other designs, the network entity 306 may be distinct from a network operator or operation of the cellular network infrastructure (e.g., NG RAN 220 and/or 5GC 210/260). For example, the network entity 306 may be a component of a private network that may be configured to communicate with the UE 302 via the base station 304 or independently from the base station 304 (e.g., over a non-cellular communication link, such as WiFi).

NR supports a number of cellular network-based positioning technologies, including downlink-based, uplink-based, and downlink-and-uplink-based positioning methods. Downlink-based positioning methods include observed time difference of arrival (OTDOA) in LTE, downlink time difference of arrival (DL-TDOA) in NR, and downlink angle-of-departure (DL-AoD) in NR. In an OTDOA or DL-TDOA positioning procedure, a UE measures the differences between the times of arrival (ToAs) of reference signals (e.g., positioning reference signals (PRS)) received from pairs of base stations, referred to as reference signal time difference (RSTD) or time difference of arrival (TDOA) measurements, and reports them to a positioning entity. More specifically, the UE receives the identifiers (IDs) of a reference base station (e.g., a serving base station) and multiple non-reference base stations in assistance data. The UE then measures the RSTD between the reference base station and each of the non-reference base stations. Based on the known locations of the involved base stations and the RSTD measurements, the positioning entity (e.g., the UE for UE-based positioning or a location server for UE-assisted positioning) can estimate the UE's location.

For DL-AoD positioning, the positioning entity uses a measurement report from the UE of received signal strength measurements of multiple downlink transmit beams to determine the angle(s) between the UE and the transmitting base station(s). The positioning entity can then estimate the location of the UE based on the determined angle(s) and the known location(s) of the transmitting base station(s).

Uplink-based positioning methods include uplink time difference of arrival (UL-TDOA) and uplink angle-of-arrival (UL-AoA). UL-TDOA is similar to DL-TDOA, but is based on uplink reference signals (e.g., sounding reference signals (SRS)) transmitted by the UE to multiple base stations. Specifically, a UE transmits one or more uplink reference signals that are measured by a reference base station and a plurality of non-reference base stations. Each base station then reports the reception time (referred to as the relative time of arrival (RTOA)) of the reference signal(s) to a positioning entity (e.g., a location server) that knows the locations and relative timing of the involved base stations. Based on the reception-to-reception (Rx-Rx) time difference between the reported RTOA of the reference base station and the reported RTOA of each non-reference base station, the known locations of the base stations, and their known timing offsets, the positioning entity can estimate the location of the UE using TDOA.

For UL-AoA positioning, one or more base stations measure the received signal strength of one or more uplink reference signals (e.g., SRS) received from a UE on one or more uplink receive beams. The positioning entity uses the signal strength measurements and the angle(s) of the receive beam(s) to determine the angle(s) between the UE and the base station(s). Based on the determined angle(s) and the known location(s) of the base station(s), the positioning entity can then estimate the location of the UE.

Downlink-and-uplink-based positioning methods include enhanced cell-ID (E-CID) positioning and multi-round-trip-time (RTT) positioning (also referred to as “multi-cell RTT” and “multi-RTT”). In an RTT procedure, a first entity (e.g., a base station or a UE) transmits a first RTT-related signal (e.g., a PRS or SRS) to a second entity (e.g., a UE or base station), which transmits a second RTT-related signal (e.g., an SRS or PRS) back to the first entity. Each entity measures the time difference between the time of arrival (ToA) of the received RTT-related signal and the transmission time of the transmitted RTT-related signal. This time difference is referred to as a reception-to-transmission (Rx-Tx) time difference. The Rx-Tx time difference measurement may be made, or may be adjusted, to include only a time difference between nearest slot boundaries for the received and transmitted signals. Both entities may then send their Rx-Tx time difference measurement to a location server (e.g., an LMF 270), which calculates the round trip propagation time (i.e., RTT) between the two entities from the two Rx-Tx time difference measurements (e.g., as the sum of the two Rx-Tx time difference measurements). Alternatively, one entity may send its Rx-Tx time difference measurement to the other entity, which then calculates the RTT. The distance between the two entities can be determined from the RTT and the known signal speed (e.g., the speed of light). For multi-RTT positioning, a first entity (e.g., a UE or base station) performs an RTT positioning procedure with multiple second entities (e.g., multiple base stations or UEs) to enable the location of the first entity to be determined (e.g., using multilateration) based on distances to, and the known locations of, the second entities. RTT and multi-RTT methods can be combined with other positioning techniques, such as UL-AoA and DL-AoD, to improve location accuracy.

The E-CID positioning method is based on radio resource management (RRM) measurements. In E-CID, the UE reports the serving cell ID, the timing advance (TA), and the identifiers, estimated timing, and signal strength of detected neighbor base stations. The location of the UE is then estimated based on this information and the known locations of the base station(s).

To assist positioning operations, a location server (e.g., location server 230, LMF 270, SLP 272) may provide assistance data to the UE. For example, the assistance data may include identifiers of the base stations (or the cells/TRPs of the base stations) from which to measure reference signals, the reference signal configuration parameters (e.g., the number of consecutive slots including PRS, periodicity of the consecutive slots including PRS, muting sequence, frequency hopping sequence, reference signal identifier, reference signal bandwidth, etc.), and/or other parameters applicable to the particular positioning method. Alternatively, the assistance data may originate directly from the base stations themselves (e.g., in periodically broadcasted overhead messages, etc.). In some cases, the UE may be able to detect neighbor network nodes itself without the use of assistance data.

In the case of an OTDOA or DL-TDOA positioning procedure, the assistance data may further include an expected RSTD value and an associated uncertainty, or search window, around the expected RSTD. In some cases, the value range of the expected RSTD may be +/−500 microseconds (μs). In some cases, when any of the resources used for the positioning measurement are in FR1, the value range for the uncertainty of the expected RSTD may be +/−32 μs. In other cases, when all of the resources used for the positioning measurement(s) are in FR2, the value range for the uncertainty of the expected RSTD may be +/−8 μs.

A location estimate may be referred to by other names, such as a position estimate, location, position, position fix, fix, or the like. A location estimate may be geodetic and comprise coordinates (e.g., latitude, longitude, and possibly altitude) or may be civic and comprise a street address, postal address, or some other verbal description of a location. A location estimate may further be defined relative to some other known location or defined in absolute terms (e.g., using latitude, longitude, and possibly altitude). A location estimate may include an expected error or uncertainty (e.g., by including an area or volume within which the location is expected to be included with some specified or default level of confidence).

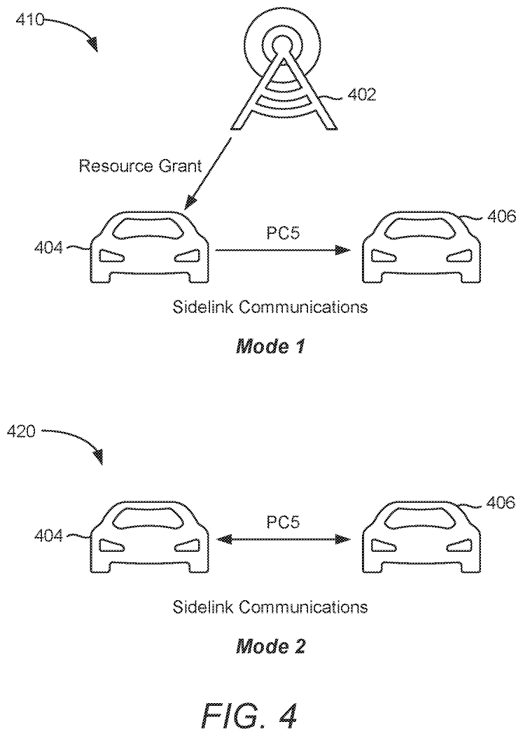

FIG. 4 illustrates the two resource allocation modes for transmissions on NR sidelinks, according to aspects of the disclosure. In the first mode 410 (labeled “Mode 1”), the base station 402 (e.g., any of the base stations described herein) allocates time and/or frequency resources for sidelink communication between the involved V-UEs 404 and 406 (e.g., any of the V-UEs or sidelink-capable UEs described herein) via DCI 3_0. Each V-UE uses the allocated resources to transmit ranging signals (e.g., SL-PRS) to the other V-UE(s).

In the second mode 420 (labeled “Mode 2”), the involved UEs 404 and 406 autonomously select sidelink resources to use for transmission of ranging signals. A V-UE can only use the first mode if it has cellular coverage, and can use the second mode regardless of whether or not it has cellular coverage. Note that although FIG. 4 illustrates two V-UEs, as will be appreciated, they need not be V-UEs, and may instead be any other type of UE capable of sidelink communication. In addition, there may be more than the two V-UEs 404 and 406 illustrated.

Signaling over the sidelink is the same between the two resource allocation modes. From the point of view of the receiver (e.g., V-UE 406), there is no difference between the modes. That is, it does not matter to the receiver whether the resources for the ranging signals were allocated by the base station 402 or the transmitter.

Mode 1 supports dynamic grant (DG), configured grant (CG) Type 1, and CG Type 2. In some cases, CG Type 1 is activated via RRC signaling from the base station 402. In some cases, the modulation and coding scheme (MCS) for sidelink transmissions is determined by the involved V-UEs 404 and 406 within limits set by the base station 402. In Mode 2, the transmitting V-UE (e.g., V-UE 404) performs channel sensing by blindly decodes all physical sidelink control channels (PSCCHs) to determine the resources reserved for other sidelink transmissions. The transmitting V-UE 404 reports available resources to its upper layer and the upper layer determines resource usage.

In addition, NR sidelinks support hybrid automatic repeat request (HARQ) retransmission. In Mode 1, the base station 402 provides a dynamic grant for HARQ feedback or activates a configured sidelink grant. The sidelink feedback can be reported back to the base station by the transmitting UE (e.g., V-UE 404).

The physical sidelink control channel (PSCCH) carries sidelink control information (SCI). First stage SCI (referred to as “SCI-1”) is transmitted on the PSCCH and contains information for resource allocation and decoding second stage SCI (referred to as “SCI-2”). SCI-2 is transmitted on the physical sidelink shared channel (PSSCH) and contains information for decoding the data that will be transmitted on the shared channel (SCH) of the sidelink. SCI-1 information is decodable by all UEs, whereas SCI-2 information may include formats that are only decodable by certain UEs. This ensures that new features can be introduced in SCI-2 while maintaining resource reservation backward compatibility in SCI-1.

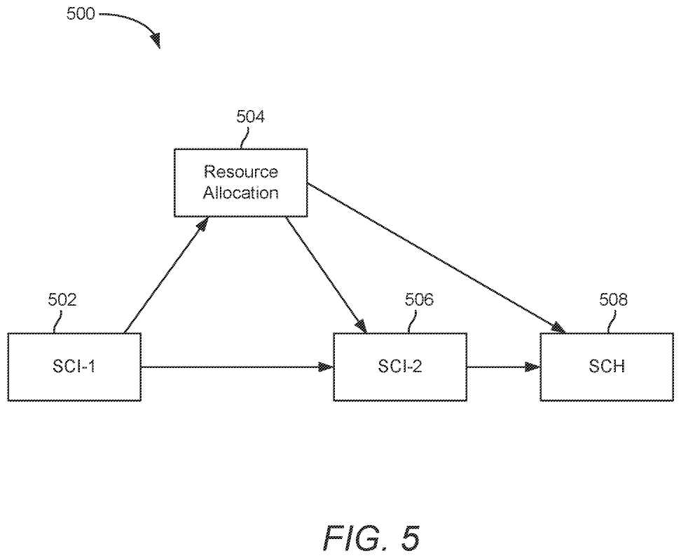

Both SCI-1 and SCI-2 use the physical downlink control channel (PDCCH) polar coding chain, illustrated in FIG. 5. FIG. 5 is a diagram 500 showing how the shared channel (SCH) is established on a sidelink between two or more UEs, according to aspects of the disclosure. Specifically, information in the SCI-1 502 is used for resource allocation 504 (by the network or the involved UEs) for the SCI-2 506 and SCH 508. In addition, information in the 5CI-1 502 is used to determine/decode the contents of the SCI-2 506 transmitted on the allocated resources. Thus, a receiver UE needs both the resource allocation 504 and the SCI-1 502 to decode the SCI-2 506. Information in the SCI-2 506 is then used to determine/decode the SCH 508.

NR is capable of supporting various sidelink ranging and positioning techniques. Sidelink-based ranging enables the determination of the relative distance(s) between UEs and optionally their absolute position(s), where the absolute position of at least one involved UE is known. This technique is valuable in situations where global navigation satellite system (GNSS) positioning is degraded or unavailable (e.g., tunnels, urban canyons, etc.) and can also enhance range and positioning accuracy when GNSS is available. Sidelink-based ranging can be accomplished using a three-way handshake for session establishment, followed by the exchange of positioning reference signals (PRS), and concluded by messaging to exchange measurements based on PRS transmission and receipt from peer UEs.

Sidelink ranging is based on calculating an inter-UE round-trip-time (RTT) measurement, as determined from the transmit and receive times of PRS (a wideband positioning signal defined in LTE and NR). Each UE reports an RTT measurement to all other participating UEs, along with its location (if known). For UEs having zero or inaccurate knowledge of their location, the RTT procedure yields an inter-UE range between the involved UEs. For UEs having accurate knowledge of their location, the range yields an absolute position. UE participation, PRS transmission, and subsequent RTT calculation is coordinated by an initial three-way messaging handshake (a PRS request, a PRS response, and a PRS confirmation), and a message exchange after PRS transmission (post PRS messages) to share measurements after receiving a peer UE's PRS.

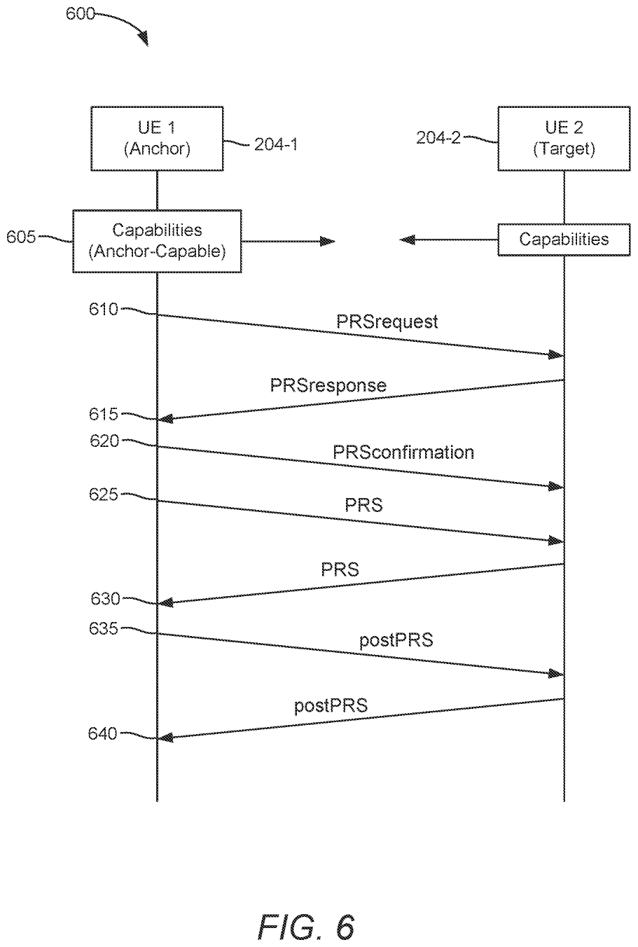

FIG. 6 illustrates an example sidelink ranging and positioning procedure 600, according to aspects of the disclosure. The sidelink ranging and positioning procedure 600 may also be referred to as a sidelink RTT positioning procedure. Sidelink ranging is based on calculating an inter-UE RTT measurement, as determined from the transmit and receive times of PRS (a wideband reference signal defined in LTE and NR for positioning). Each UE reports an RTT measurement to all other participating UEs, along with its location (if known). For UEs having zero or inaccurate knowledge of their location, the RTT procedure yields an inter-UE range between the involved UEs. For UEs having accurate knowledge of their location, the range yields an absolute location. UE participation, PRS transmission, and subsequent RTT calculation is coordinated by an initial three-way messaging handshake (a PRS request, a PRS response, and a PRS confirmation), and a message exchange after PRS transmission (post PRS messages) to share measurements after receiving a peer UE's PRS.

The sidelink ranging and positioning procedure 600 (or session) begins with the broadcast of capability information by the involved peer UEs at stage 605. As shown in FIG. 6, one of the peer UEs, UE 204-1 (e.g., any of the sidelink-capable UEs described herein), is capable of being an anchor UE for the sidelink ranging and positioning procedure 600, meaning it has a known location. As such, the anchor UE 204-1 includes an indication in its capability message(s) that it is capable of being an anchor UE for the sidelink ranging and positioning procedure 600. The capability message(s) may also include the location of the anchor UE 204-1, or this may be provided later. The other UE, UE 204-2 (e.g., any other of the sidelink-capable UEs described herein), is a target UE, meaning it has an unknown or inaccurate location and is attempting to be located. Based on the capability information received from the anchor UE 204-1, indicating that the anchor UE 204-1 is an anchor UE, the target UE 204-2 knows that it will be able to determine its location based on performing the sidelink ranging and positioning procedure 600 with the anchor UE 204-1.

After the initial capability exchange, the involved UEs 204 perform a three-way messaging handshake. At stage 610, the anchor UE 204-1 transmits a PRS request (labeled “PRSrequest”) to the target UE 204-2. At stage 615, the target UE 204-2 transmits a PRS response (labeled “PRSresponse”) to the anchor UE 204-1. At stage 620, the anchor UE 204-1 transmits a PRS confirmation to the target UE 204-2. At this point, the three-way messaging handshake is complete. Note that although FIG. 6 illustrates the anchor UE 204-1 initiating the three-way message handshake, it may instead be initiated by the target UE 204-2.

At stages 625 and 630, the involved peer UEs 204 transmit PRS to each other. The resources on which the PRS are transmitted may be configured/allocated by the network (e.g., one of the UE's 204 serving base station) or negotiated by the UEs 204 during the three-way messaging handshake. The anchor UE 204-1 measures the transmission-to-reception (Tx-Rx) time difference between the transmission time of PRS at stage 625 and the reception time of PRS at stage 630. The target UE 204-2 measures the reception-to-transmission (Rx-Tx) time difference between the reception time of PRS at stage 625 and the transmission time of PRS at stage 630. Note that although FIG. 6 illustrates the anchor UB 204-1 transmitting PRS first, the target UE 204-2 may instead transmit PRS first.

At stages 635 and 640, the peer UEs 204 exchange their respective time difference measurements in post PRS messages (labeled “postPRS”). If the anchor UE 204-1 has not yet provided its location to the target UE 204-2, it does so at this point. Each UE 204 is then able to determine the RTT between each UE 204 based on the Tx-Rx and Rx-Tx time difference measurements (specifically, the difference between the Tx-Rx and Rx-Tx time difference measurements). Based on the RTT measurement and the speed of light, each UE 204 can then estimate the distance (or range) between the two UEs 204 (specifically, half the RTT measurement multiplied by the speed of light). Since the target UE 204-2 also has the absolute location (e.g., geographic coordinates) of the anchor UE 204-1, the target UE 204-2 can use that location and the distance to the anchor UE 204-1 to determine its own absolute location.

Note that while FIG. 6 illustrates two UEs 204, a UE may perform, or attempt to perform, the sidelink ranging and positioning procedure 600 with multiple UEs.

Sidelink communication takes place in transmission or reception resource pools. In the frequency domain, the minimum resource allocation unit is a sub-channel (e.g., a collection of consecutive PRBs in the frequency domain). In the time domain, resource allocation is in one slot intervals. However, some slots are not available for sidelink, and some slots contain feedback resources. In addition, sidelink resources can be (pre) configured to occupy fewer than the 14 symbols of a slot.

Sidelink resources are configured at the radio resource control (RRC) layer. The RRC configuration can be by pre-configuration (e.g., preloaded on the UE) or configuration (e.g., from a serving base station).

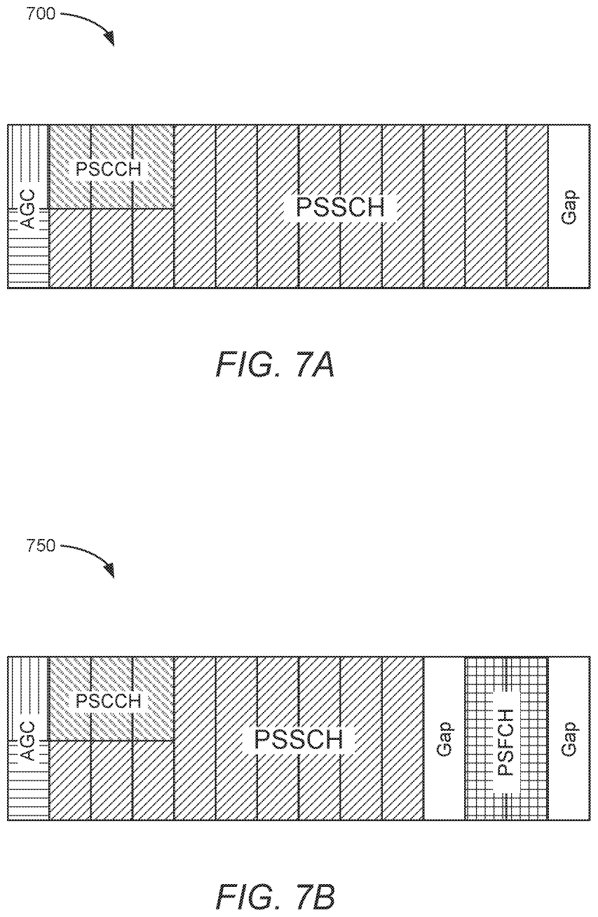

NR sidelinks support hybrid automatic repeat request (HARQ) retransmission. FIG. 7A is a diagram 700 of an example slot structure without feedback resources, according to aspects of the disclosure. In the example of FIG. 7A, time is represented horizontally and frequency is represented vertically. In the time domain, the length of each block is one orthogonal frequency division multiplexing (OFDM) symbol, and the 14 symbols make up a slot. In the frequency domain, the height of each block is one sub-channel. Currently, the (pre) configured sub-channel size can be selected from the set of {10, 15, 20, 25, 50, 75, 100} physical resource blocks (PRBs).

For a sidelink slot, the first symbol is a repetition of the preceding symbol and is used for automatic gain control (AGC) setting. This is illustrated in FIG. 7A by the vertical and horizontal hashing. As shown in FIG. 7A, for sidelink, the physical sidelink control channel (PSCCH) and the physical sidelink shared channel (PSSCH) are transmitted in the same slot. Similar to the physical downlink control channel (PDCCH), the PSCCH carries control information about sidelink resource allocation and descriptions about sidelink data transmitted to the UE. Likewise, similar to the physical downlink shared channel (PDSCH), the PSSCH carries user data for the UE. In the example of FIG. 7A, the PSCCH occupies half the bandwidth of the sub-channel and only three symbols. Finally, a gap symbol is present after the PSSCH.

FIG. 7B is a diagram 750 of an example slot structure with feedback resources, according to aspects of the disclosure. In the example of FIG. 7B, time is represented horizontally and frequency is represented vertically. In the time domain, the length of each block is one OFDM symbol, and the 14 symbols make up a slot. In the frequency domain, the height of each block is one sub-channel.

The slot structure illustrated in FIG. 7B is similar to the slot structure illustrated in FIG. 7A, except that the slot structure illustrated in FIG. 7B includes feedback resources. Specifically, two symbols at the end of the slot have been dedicated to the physical sidelink feedback channel (PSFCH). The first PSFCH symbol is a repetition of the second PSFCH symbol for AGC setting. In addition to the gap symbol after the PSSCH, there is a gap symbol after the two PSFCH symbols. Currently, resources for the PSFCH can be configured with a periodicity selected from the set of {0, 1, 2, 4} slots.

Sidelink slot structures support one- and two-layer PSSCH transmissions with QPSK, 16-QAM, 64-QAM, and 256-QAM. In addition, there are different patterns of DMRS that may be transmitted in the PSSCH. Specifically, two, three, and four symbol DMRS patterns for five, six, seven, eight, nine, ten, eleven, and twelve symbol PSSCH can be (pre-) configured for use by the transmitter. The transmitter selects a DMRS pattern based on channel conditions and signals the pattern in SCI-1.

The number of PSSCH DMRS is determined from SCI-1. The DMRS positions are determined as relative positions from the first symbol of the PSCCH with the patterns described in Table 1. Specifically, the position(s) of the DMRS symbols is given by l, and l_{d} is the duration in symbols of the scheduled resources for transmission of the PSSCH and the associated PSCCH, including the AGC OFDM symbol.

TABLE 1

| | DMRS Position l | | | | | |
|---|---|---|---|---|---|---|
| | PSCCH Duration 2 Symbols | | | PSCCH Duration 3 Symbols | | |
| l_{d.} in | Number of PSSCH DMRS | | | Number of PSSCH DMRS | | |
| symbols | 2 | 3 | 4 | 2 | 3 | 4 |
| 6 | 1, 5 | | | 1, 5 | | |
| 7 | 1, 5 | | | 1, 5 | | |
| 8 | 1, 5 | | | 1, 5 | | |
| 9 | 3, 8 | 1, 4, 7 | | 4, 8 | 1, 4, 7 | |
| 10 | 3, 8 | 1, 4, 7 | | 4, 8 | 1, 4, 7 | |
| 11 | 3, 10 | 1, 5, 9 | 1, 4, 7, 10 | 4, 10 | 1, 5, 9 | 1, 4, 7, 10 |
| 12 | 3, 10 | 1, 5, 9 | 1, 4, 7, 10 | 4, 10 | 1, 5, 9 | 1, 4, 7, 10 |
| 13 | 3, 10 | 1, 6, 11 | 1, 4, 7, 10 | 4, 10 | 1, 6, 11 | 1, 4, 7, 10 |

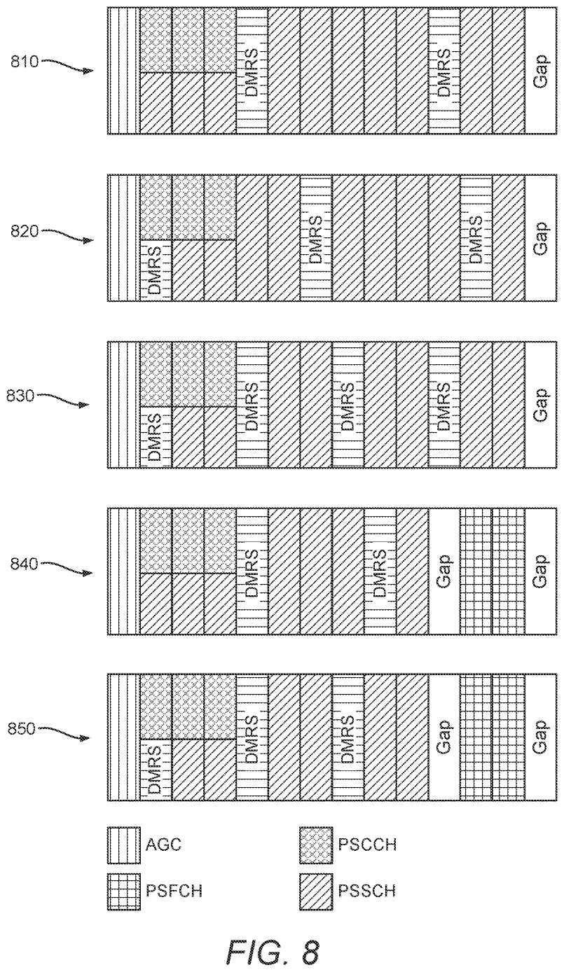

FIG. 8 illustrates example DMRS patterns for nine and twelve symbol PSSCH, according to aspects of the disclosure. Specifically, DMRS pattern 810 is a two-symbol DMRS pattern for a 12-symbol PSSCH (13 including the AGC, i.e., the last row of Table 1), DMRS pattern 820 is a three-symbol DMRS pattern for a 12-symbol PSSCH (13 including the AGC), DMRS pattern 830 is a four-symbol DMRS pattern for a 12-symbol PSSCH (13 including the AGC), DMRS pattern 840 is a two-symbol DMRS pattern for a 9-symbol PSSCH (10 including the AGC), and DMRS pattern 850 is a three-symbol DMRS pattern for a 9-symbol PSSCH (10 including the AGC).

The first 13 symbols of a slot in the time domain and the allocated subchannel(s) in the frequency domain form a sidelink resource pool. A sidelink resource pool may include resources for sidelink communication (transmission and/or reception), sidelink positioning (referred to as a resource pool for positioning (RP-P)), or both communication and positioning. A resource pool configured for both communication and positioning is referred to as a “shared” resource pool. In a shared resource pool, the RP-P is indicated by an offset, periodicity, number of consecutive symbols within a slot (e.g., as few as one symbol), and/or the bandwidth within a component carrier (or the bandwidth across multiple component carriers). In addition, the RP-P can be associated with a zone or a distance from a reference location.

A base station (or a UE, depending on the resource allocation mode described above with reference to FIG. 4) can assign, to another UE, one or more resource configurations from the RP-P. Additionally or alternatively, a UE (e.g., a relay or a remote UE) can request one or more RP-P configurations, and it can include in the request one or more of the following: (1) its location information (or zone identifier), (2) periodicity, (3) bandwidth, (4) offset, (5) number of symbols, and (6) whether a configuration with “low interference” is needed (which can be determined through an assigned quality of service (QoS) or priority).

A base station or a UE can configure/assign rate matching resources or RP-P for rate matching and/or muting to a sidelink UE such that when a collision exists between the assigned resources and another resource pool that contains data (PSSCH) and/or control (PSCCH), the sidelink UE is expected to rate match, mute, and/or puncture the data, DMRS, and/or CSI-RS within the colliding resources. This would enable orthogonalization between positioning and data transmissions for increased coverage of SL-PRS signals.

As shown in the example of FIG. 6, sidelink positioning may involve transmission and reception of sidelink positioning reference signals (SL-PRS) between multiple UEs. In an aspect, the SL-PRS resources may be shared with other resources transmitted or received in sidelink communications channels. Additionally, or in the alternative, SL-PRS may be based on dedicated resources for the SL-PRS rather than sharing the resources with the sidelink communication channels. In each such scenario, the sidelink control information (e.g., SCI-1) required for SL-PRS is transmitted on the physical sidelink control channel (PSCCH).

Current proposals limit the PSCCH transmissions in various manners. For example, current proposals limit the frequency span of the PSCCH to a single sub-channel. Additionally, the maximum number of PRBs allowed for allocation to the PSCCH is limited to 25 PRBs. Such requirements imply that the number of PRBs that can be used for the PSCCH is bounded by the number of PRBs in a single sub-channel.

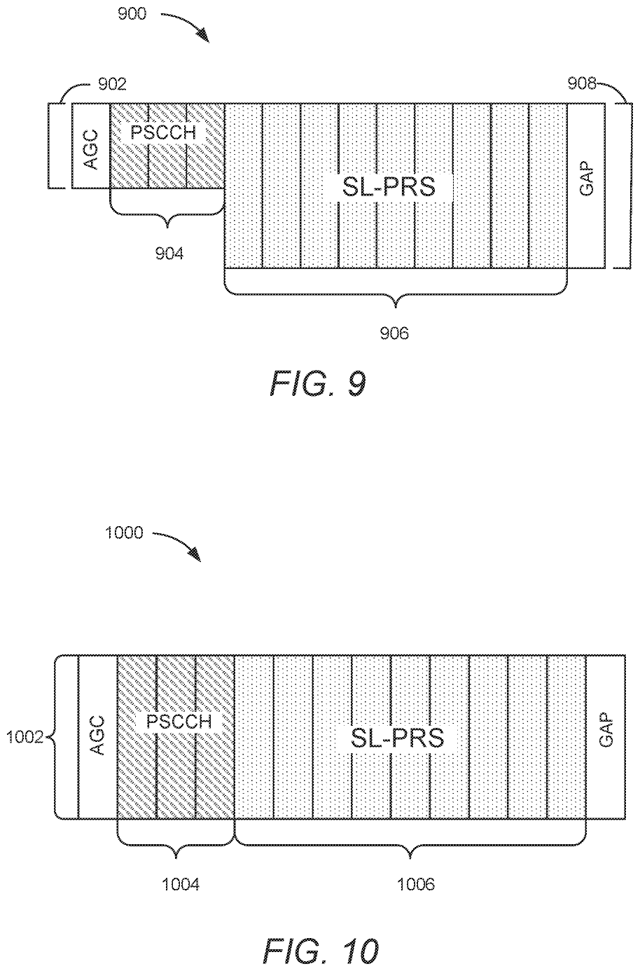

FIG. 9 shows an example of a slot structure 900 having dedicated sidelink positioning reference signals (SL-PRS), according to aspects of the disclosure. The example slot structure 900 represents a slot structure having the proposed limitations noted above. In this example, the PSCCH 904 occupies three symbols and the SL-PRS 906 occupies nine symbols adjacent to the PSCCH 904. Although the PSCCH 904 spans a bandwidth 902, the SL-PRS from the dedicated resource pool have a larger bandwidth 908. Additionally, the SL-PRS may use a comb-N structure in the frequency domain, which may occupy multiple subchannels, including subchannels outside the single subchannel currently allowed for the PSCCH.

Since the PSCCH and SL-PRS may occupy different bandwidths in the existing slot structure shown in FIG. 9, certain aspects of the disclosure are implemented with a recognition that transmitting them contiguously may lead to phase discontinuity and transient behavior, causing the loss of few symbols during the transition to the transmission of the SL-PRS symbols. Accordingly, certain aspects of the disclosure are implemented to match the bandwidth of the PSCCH with the bandwidth of the SL-PRS of the dedicated resource pool to achieve a seamless transition between the symbols of the PSCCH and the SL-PRS.

In accordance with certain aspects of the disclosure, the PSCCH is configured to span multiple subchannels corresponding to at least as many subchannels as spanned by the SL-PRS of the dedicated resource pool within a single slot structure. In certain aspects, the maximum (pre-) configurable number of resource blocks allocated for the PSCCH may be at least as many resource blocks as that of the SL-PRS of the dedicated resource pool. In certain aspects, the slot structure 900 may have an AGC symbol transmitted at the beginning of the slot structure 900 and a symbol gap at the end of the slot structure 900.

FIG. 10 shows an example of a slot structure 1000 having dedicated SL-PRS from a sidelink resource pool, according to aspects of the disclosure. The example slot structure 1000 represents a slot structure providing a seamless transition between the PSCCH and the SL-PRS. In this example, the PSCCH 1004 occupies three symbols and the SL-PRS 1006 occupies nine symbols adjacent to the PSCCH 1004. Both the PSCCH 1004 and SL-PRS 1006 span a bandwidth 1002 so that the SL-PRS 1006 from the dedicated resource pool has the same bandwidth as the PSCCH 1004. In accordance with certain aspects of the disclosure, the bandwidth 1002 may span multiple sub-channels. Additionally, the SL-PRS 1006 and PSCCH 1004 may span the same number of resource blocks, which may be the same set of resource blocks. In accordance with aspects of the disclosure, the symbols of the PSCCH 1004 occupy a first set of contiguous symbols that are immediately adjacent to a second set of contiguous symbols occupied by the SL-PRS 1006 transmission/reception. The SL-PRS 1006 may use a comb-N structure in the frequency domain, which may occupy multiple subchannels included in the bandwidth 1002 yet still maintain a seamless transmission/reception of symbols across the duration of the PSCCH 1004 and SL-PRS 1006. In certain aspects, the slot structure 1000 may have an AGC symbol transmitted at the beginning of the slot structure 1000 and a symbol gap at the end of the slot structure 1000.

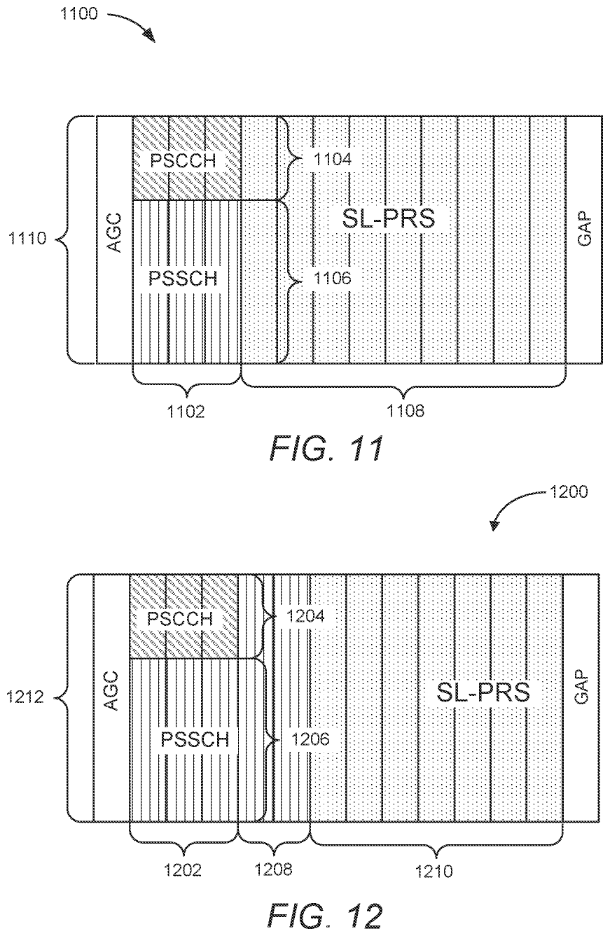

FIG. 11 shows another example of a slot structure 1100 having dedicated SL-PRS from a sidelink resource pool, according to aspects of the disclosure. In this example, the slot structure 1100 includes PSCCH in a first set of contiguous symbols 1102 of the slot structure 1100. Here, the PSCCH spans a first bandwidth 1106. The slot structure 1100 further includes a PSSCH in the same first set of contiguous symbols 1102 of the slot structure 1100. The PSSCH spans at least a second bandwidth 1106 adjacent to the first bandwidth 1104. Still further, the slot structure 1100 includes SL-PRS occupying a second set of contiguous symbols 1108 of the slot structure 1100 that is adjacent to the first set of contiguous symbols 1102 having the PSCCH and PSSCH. The SL-PRS span a third bandwidth 1110 that is equal to the sum of the first bandwidth 1104 and the second bandwidth 1106. The third bandwidth 1110 corresponds to a sum of the first bandwidth 1104 and the second bandwidth 1106 thereby providing a seamless transition between transmission/reception of the first set of contiguous symbols 1102 of the PSCCH and PSSCH and the second set of contiguous symbols 1108 of the SL-PRS.

The symbols of the PSSCH may include various information. In an aspect, the PSSCH may include information relating to the configuration of the SL-PRS (e.g., comb pattern, transmission parameters, etc.). In various aspects, the PSSCH may include 1) sidelink control information 2 (SCI-2), 2) a duplicate of at least a subset of the information included in the sidelink control information 1 (SCI-1), 3) sidelink shared channel (SL-SCH) information, or 4) any combination thereof. The SL-SCH information may include MAC control element (MAC-CE) and/or higher layer message information including information about the SL-PRS. Additionally, or in the alternative, SL-SCH information may be a duplicate of at least a subset of the information already in the SCI-1 or could provide additional information. In accordance with certain aspects of the disclosure, the slot structure 1000 may include a new DMRS pattern, or, an existing DMRS pattern or a punctured DMRS pattern that is modified so that the resources of SL-PRS are utilized efficiently.

The PSSCH may carry SCI-2 and/or SL-SCH, which may carry various information. In an aspect, the content of SCI-2 may include information about the SL-PRS transmission. Additionally, or in the alternative, the SCI-2 may include a duplicate of at least a subset of the information already in SCI-1 and/or additional information. In an aspect, the content of the SL-SCH may include MAC-CE and/or higher layer message having information about the SL-PRS transmission. Additionally, or in the alternative, the SL-SCH may include a duplicate of at least a subset of the information already in SCI-1 and/or may include additional information.

FIG. 12 shows another example of a slot structure 1200 having dedicated SL-PRS from a sidelink resource pool, according to aspects of the disclosure. In this example, the slot structure 1200 includes PSCCH and PSSCH in a first set of contiguous symbols 1202 of the slot structure 1200. Here, the PSCCH spans a first bandwidth 1204 and the PSSCH spans at a second bandwidth 1206 adjacent to the first bandwidth 1204. Still further, the slot structure 1200 includes a second set of contiguous symbols 1208 also including the PSSCH. The second set of contiguous symbols 1208 is adjacent to the first set of contiguous symbols 1202. The slot structure 1200 also includes SL-PRS occupying a third set of contiguous symbols 1210 of the slot structure 1200 that is adjacent to the second set of contiguous symbols 1208 having the PSSCH. The SL-PRS span a third bandwidth 1212 that is the same as the PSSCH in the second set of contiguous symbols 1208 and also equal to the sum of the first bandwidth 1204 and the second bandwidth 1206. Since the third bandwidth 1212 corresponds to a sum of the first bandwidth 1204 and the second bandwidth 1206 and is the same as the bandwidth of the PSSCH, the slot structure 1200 provides a seamless transition between transmission/reception of the first set of contiguous symbols 1202 of the PSCCH and PSSCH, the second set of contiguous symbols 1208, and the third set of contiguous symbols 1210 of the SL-PRS. In an aspect, the PSSCH may carry the same type of information noted in connection with the PSSCH of FIG. 11.

Further, the slot structure 1200 may include a DMRS pattern or puncture DMRS pattern that is modified from those shown in FIG. 8 so that the resources of the SL-PRS are utilized efficiently. In this regard, as shown in FIG. 8, the slot structures can have different numbers of DMRS symbols dispersed throughout the slot. However, the SL-PRS (e.g., SL-PRS 1006 of FIG. 10) do not require DMRS as they are positioning signals with a comb structure. Spreading multiple DMRS symbols over the entire slot structure (e.g., slot structure 1000 of FIG. 10), would result in the inclusion of unnecessary symbols. To reduce the inclusion of unnecessary symbols, a different DMRS pattern than shown in FIG. 8 may be used when SL-PRS are carried in the slot structure. For example, one DMRS may be associated with each physical channel that does not carry the SL-PRS (e.g., the PSCCH and, if used, the PSSCH) while the portion of the slot structure carrying the SL-PRS omits such DMRS. Alternatively, the existing DMRS patterns shown in FIG. 8 may include a new DMRS pattern, or, an existing DMRS pattern or a punctured DMRS pattern that is modified so that the resources of SL-PRS are utilized efficiently.

In accordance with certain aspects of the disclosure, slot structures may include a PSCCH and SL-PRS that have the same number of symbols and are frequency division multiplexed. In an aspect, the PSCCH may occupy some subchannels and the SL-PRS would occupy other subchannels. Both PSCCH and SL-PRS would occupy the same number of symbols within the slot so that the bandwidth of the PSCCH matches the bandwidth of the SL-PRS. In an aspect, the subchannels of the PSCCH may be interleaved with the subchannels of the SL-PRS, or they may be grouped together. In this manner, the bandwidth of the entire slot may remain constant over the slot duration without symbol loss due to bandwidth transitions (e.g., the bandwidth of the PSCCH matches the bandwidth of the SL-PRS).

According to various aspects of the disclosure, the bandwidth of a channel may be expressed as a number of resource blocks, a set of resource blocks, etc. As such, a channel having the same bandwidth may be expressed as having the same number of resource blocks, the same set of resource blocks, etc.

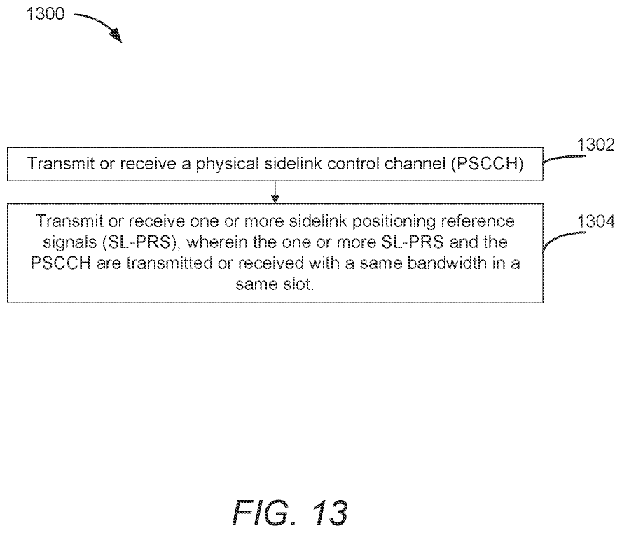

FIG. 13 illustrates an example method 1300 of wireless communication performed by a wireless communication device, according to aspects of the disclosure. At operation 1302, the wireless communication device transmits or receives a physical sidelink control channel (PSCCH). In an aspect, operation 1302 may be performed by the one or more WWAN transceivers 310, the one or more processors 332, memory 340, and/or positioning component 342, any or all of which may be considered means for performing this operation.

At operation 1304, the wireless communication device transmits or receives one or more sidelink positioning reference signals (SL-PRS), wherein the one or more SL-PRS and the PSCCH are transmitted or received with a same bandwidth in a same slot. In an aspect, operation 1304 may be performed by the one or more WWAN transceivers 310, the one or more processors 332, memory 340, and/or positioning component 342, any or all of which may be considered means for performing this operation.

In some aspects, the one or more SL-PRS and the PSCCH span multiple sub-channels. In some aspects, the one or more SL-PRS and the PSCCH span a same number of resource blocks. In some aspects, the one or more SL-PRS and the PSCCH are transmitted or received in a same set of resource blocks. In some aspects, the PSCCH is transmitted or received in a first set of symbols; and the one or more SL-PRS is transmitted or received in a second set of symbols. In some aspects, the second set of symbols is adjacent to the first set of symbols.

A technical advantage of method 1300 is that the method utilizes a sidelink slot structure that may use a dedicated set of SL-PRS of a sidelink resource set in which the transmission and/or reception of the SL-PRS and PSCCH may take place in a seamless manner.

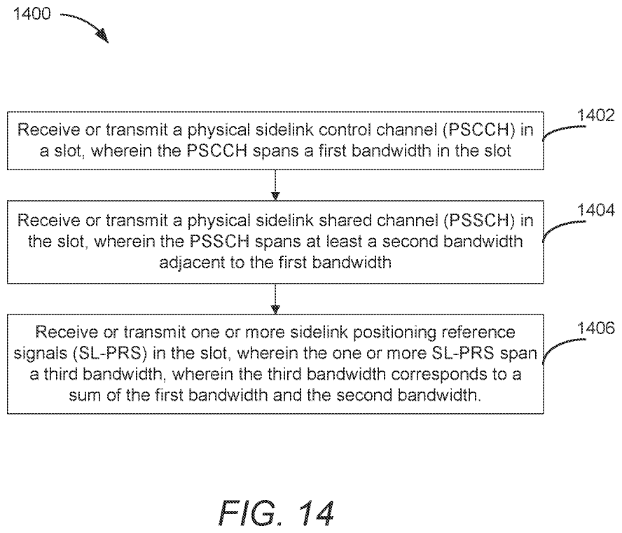

FIG. 14 illustrates an example method 1400 of wireless communication performed by a wireless communication device, according to aspects of the disclosure. At operation 1402, the wireless communication device receives or transmits a physical sidelink control channel (PSCCH) in a slot, wherein the PSCCH spans a first bandwidth in the slot. In an aspect, operation 1402 may be performed by the one or more WWAN transceivers 310, the one or more processors 332, memory 340, and/or positioning component 342, any or all of which may be considered means for performing this operation.

At operation 1404, the wireless communication device receives or transmits a physical sidelink shared channel (PSSCH) in the slot, wherein the PSSCH spans at least a second bandwidth adjacent to the first bandwidth. In an aspect, operation 1404 may be performed by the one or more WWAN transceivers 310, the one or more processors 332, memory 340, and/or positioning component 342, any or all of which may be considered means for performing this operation.

At operation 1406, the wireless communication device receives or transmits one or more sidelink positioning reference signals (SL-PRS) in the slot, wherein the one or more SL-PRS span a third bandwidth, wherein the third bandwidth corresponds to a sum of the first bandwidth and the second bandwidth. In an aspect, operation 1406 may be performed by the one or more WWAN transceivers 310, the one or more processors 332, memory 340, and/or positioning component 342, any or all of which may be considered means for performing this operation.

In some aspects, the PSCCH and the PSSCH are transmitted or received in a first set of contiguous symbols; and the one or more SL-PRS are received in a second set of contiguous symbols adjacent to the first set of contiguous symbols. In some aspects, the PSCCH is transmitted or received in a first set of contiguous symbols; the PSSCH is transmitted or received in the first set of contiguous symbols and a second set of contiguous symbols adjacent to the first set of contiguous symbols; and the one or more SL-PRS are transmitted or received in a third set of contiguous symbols adjacent to the second set of contiguous slots. In various aspects, the PSSCH may include 1) sidelink control information 2 (SCI-2), 2) a duplicate of at least a subset of the information included in the sidelink control information 1 (SCI-1), 3) sidelink shared channel (SL-SCH) information, or 4) any combination thereof.

A technical advantage of method 1400 is that the method utilizes a sidelink slot structure that may use a dedicated set of SL-PRS of a sidelink resource set in which the transmission and/or reception of the SL-PRS, PSCCH, PSSCH may take place in a seamless manner.

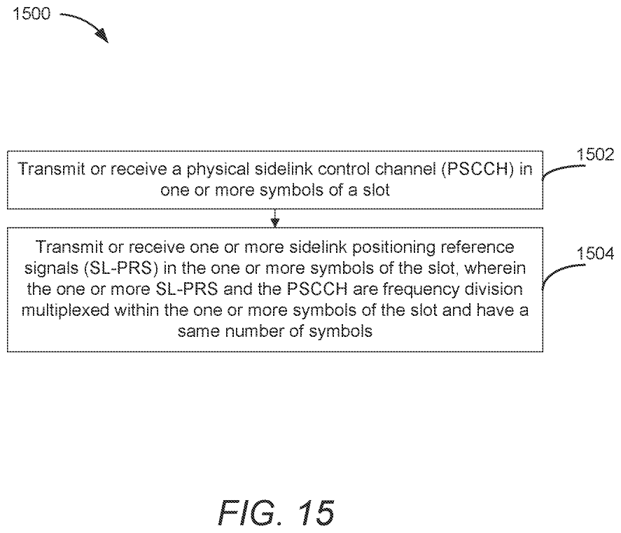

FIG. 15 illustrates an example method 1500 of wireless communication performed by a wireless communication device. At operation 1502, the wireless communication device transmits or receives a physical sidelink control channel (PSCCH) in one or more symbols of a slot. In an aspect, operation 1502 may be performed by the one or more WWAN transceivers 310, the one or more processors 332, memory 340, and/or positioning component 342, any or all of which may be considered means for performing this operation.

At operation 1504, the wireless communication device transmits or receives one or more sidelink positioning reference signals (SL-PRS) in the one or more symbols of the slot, wherein the one or more SL-PRS and the PSCCH are frequency division multiplexed within the one or more symbols of the slot and have a same number of symbols. In an aspect, operation 1504 may be performed by the one or more WWAN transceivers 310, the one or more processors 332, memory 340, and/or positioning component 342, any or all of which may be considered means for performing this operation.

A technical advantage of method 1500 is that the method utilizes a sidelink slot structure that may use a dedicated set of SL-PRS of a sidelink resource set in which the transmission and/or reception of the SL-PRS and PSCCH may take place in a seamless manner.

In the detailed description above it can be seen that different features are grouped together in examples. This manner of disclosure should not be understood as an intention that the example clauses have more features than are explicitly mentioned in each clause. Rather, the various aspects of the disclosure may include fewer than all features of an individual example clause disclosed. Therefore, the following clauses should hereby be deemed to be incorporated in the description, wherein each clause by itself can stand as a separate example. Although each dependent clause can refer in the clauses to a specific combination with one of the other clauses, the aspect(s) of that dependent clause are not limited to the specific combination. It will be appreciated that other example clauses can also include a combination of the dependent clause aspect(s) with the subject matter of any other dependent clause or independent clause or a combination of any feature with other dependent and independent clauses. The various aspects disclosed herein expressly include these combinations, unless it is explicitly expressed or can be readily inferred that a specific combination is not intended (e.g., contradictory aspects, such as defining an element as both an electrical insulator and an electrical conductor). Furthermore, it is also intended that aspects of a clause can be included in any other independent clause, even if the clause is not directly dependent on the independent clause.

Implementation examples are described in the following numbered clauses:

Clause 1. A method of wireless communication performed by a wireless communication device, comprising: transmitting or receiving a physical sidelink control channel (PSCCH); and transmitting or receiving one or more sidelink positioning reference signals (SL-PRS), wherein the one or more SL-PRS and the PSCCH are transmitted or received with a same bandwidth in a same slot.

Clause 2. The method of clause 1, wherein: the one or more SL-PRS and the PSCCH span multiple sub-channels.

Clause 3. The method of any of clauses 1 to 2, wherein: the one or more SL-PRS and the PSCCH span a same number of resource blocks.

Clause 4. The method of any of clauses 1 to 3, wherein: the one or more SL-PRS and the PSCCH are transmitted or received in a same set of resource blocks.

Clause 5. The method of clause 4, wherein: the PSCCH is transmitted or received in a first set of symbols; and the one or more SL-PRS is transmitted or received in a second set of symbols.

Clause 6. The method of clause 5, wherein: the second set of symbols is adjacent to the first set of symbols.

Clause 7. The method of clause 6, wherein: the one or more SL-PRS and the PSCCH are transmitted or received in a same set of resource blocks.

Clause 8. A method of wireless communication performed by a wireless communication device, comprising: receiving or transmitting a physical sidelink control channel (PSCCH) in a slot, wherein the PSCCH spans a first bandwidth in the slot; receiving or transmitting a physical sidelink shared channel (PSSCH) in the slot, wherein the PSSCH spans at least a second bandwidth adjacent to the first bandwidth; and receiving or transmitting one or more sidelink positioning reference signals (SL-PRS) in the slot, wherein the one or more SL-PRS span a third bandwidth, wherein the third bandwidth corresponds to a sum of the first bandwidth and the second bandwidth.

Clause 9. The method of clause 8, wherein: the PSCCH and the PSSCH are transmitted or received in a first set of contiguous symbols; and the one or more SL-PRS are received in a second set of contiguous symbols adjacent to the first set of contiguous symbols.

Clause 10. The method of any of clauses 8 to 9, wherein: the PSCCH is transmitted or received in a first set of contiguous symbols; the PSSCH is transmitted or received in the first set of contiguous symbols and a second set of contiguous symbols adjacent to the first set of contiguous symbols; and the one or more SL-PRS are transmitted or received in a third set of contiguous symbols adjacent the second set of contiguous slots.

Clause 11. The method of any of clauses 8 to 10, wherein: the PSSCH includes sidelink control information 2 (SCI-2); a duplicate of at least a subset of information in sidelink control information 1 (SCI-1); sidelink shared channel (SL-SCH) information; or any combination thereof.

Clause 12. The method of clause 11, wherein: the PSCCH includes information relating to the one or more SL-PRS.

Clause 13. A method of wireless communication performed by a wireless communication device, comprising: transmitting or receiving a physical sidelink control channel (PSCCH) in one or more symbols of a slot; and transmitting or receiving one or more sidelink positioning reference signals (SL-PRS) in the one or more symbols of the slot, wherein the one or more SL-PRS and the PSCCH are frequency division multiplexed within the one or more symbols of the slot and have a same number of symbols.

Clause 14. A wireless communication device, comprising: a memory; at least one transceiver; and at least one processor communicatively coupled to the memory and the at least one transceiver, the at least one processor configured to: transmit or receive, via the at least one transceiver, a physical sidelink control channel (PSCCH); and transmit or receive, via the at least one transceiver, one or more sidelink positioning reference signals (SL-PRS), wherein the one or more SL-PRS and the PSCCH are transmitted or received with a same bandwidth in a same slot.

Clause 15. The wireless communication device of clause 14, wherein: the one or more SL-PRS and the PSCCH span multiple sub-channels.

Clause 16. The wireless communication device of any of clauses 14 to 15, wherein: the one or more SL-PRS and the PSCCH span a same number of resource blocks.

Clause 17. The wireless communication device of any of clauses 14 to 16, wherein: the one or more SL-PRS and the PSCCH are transmitted or received in a same set of resource blocks.

Clause 18. The wireless communication device of clause 17, wherein: the PSCCH is transmitted or received in a first set of symbols; and the one or more SL-PRS is transmitted or received in a second set of symbols.

Clause 19. The wireless communication device of clause 18, wherein: the second set of symbols is adjacent to the first set of symbols.

Clause 20. The wireless communication device of clause 19, wherein: the one or more SL-PRS and the PSCCH are transmitted or received in a same set of resource blocks.

Clause 21. A wireless communication device, comprising: a memory; at least one transceiver; and at least one processor communicatively coupled to the memory and the at least one transceiver, the at least one processor configured to: receive or transmit, via the at least one transceiver, a physical sidelink control channel (PSCCH) in a slot, wherein the PSCCH spans a first bandwidth in the slot; receive or transmit, via the at least one transceiver, a physical sidelink shared channel (PSSCH) in the slot, wherein the PSSCH spans at least a second bandwidth adjacent to the first bandwidth; and receive or transmit, via the at least one transceiver, one or more sidelink positioning reference signals (SL-PRS) in the slot, wherein the one or more SL-PRS span a third bandwidth, wherein the third bandwidth corresponds to a sum of the first bandwidth and the second bandwidth.

Clause 22. The wireless communication device of clause 21, wherein: the PSCCH and the PSSCH are transmitted or received in a first set of contiguous symbols; and the one or more SL-PRS are received in a second set of contiguous symbols adjacent the first set of contiguous symbols.

Clause 23. The wireless communication device of any of clauses 21 to 22, wherein: the PSCCH is transmitted or received in a first set of contiguous symbols; the PSSCH is transmitted or received in the first set of contiguous symbols and a second set of contiguous symbols adjacent to the first set of contiguous symbols; and the one or more SL-PRS are transmitted or received in a third set of contiguous symbols adjacent the second set of contiguous slots.

Clause 24. The wireless communication device of any of clauses 21 to 23, wherein: the PSSCH includes sidelink control information 2 (SCI-2); a duplicate of at least a subset of information in sidelink control information 1 (SCI-1); sidelink shared channel (SL-SCH) information; or any combination thereof.

Clause 25. The wireless communication device of clause 24, wherein: the PSCCH includes information relating to the one or more SL-PRS.

Clause 26. A wireless communication device, comprising: a memory; at least one transceiver; and at least one processor communicatively coupled to the memory and the at least one transceiver, the at least one processor configured to: transmit or receive, via the at least one transceiver, a physical sidelink control channel (PSCCH) in one or more symbols of a slot; and transmit or receive, via the at least one transceiver, one or more sidelink positioning reference signals (SL-PRS) in the one or more symbols of the slot, wherein the one or more SL-PRS and the PSCCH are frequency division multiplexed within the one or more symbols of the slot and have a same number of symbols.

Clause 27. A wireless communication device, comprising: means for transmitting or receiving a physical sidelink control channel (PSCCH); and means for transmitting or receiving one or more sidelink positioning reference signals (SL-PRS), wherein the one or more SL-PRS and the PSCCH are transmitted or received with a same bandwidth in a same slot.

Clause 28. The wireless communication device of clause 27, wherein: the one or more SL-PRS and the PSCCH span multiple sub-channels.

Clause 29. The wireless communication device of any of clauses 27 to 28, wherein: the one or more SL-PRS and the PSCCH span a same number of resource blocks.

Clause 30. The wireless communication device of any of clauses 27 to 29, wherein: the one or more SL-PRS and the PSCCH are transmitted or received in a same set of resource blocks.

Clause 31. The wireless communication device of clause 30, wherein: the PSCCH is transmitted or received in a first set of symbols; and the one or more SL-PRS is transmitted or received in a second set of symbols.

Clause 32. The wireless communication device of clause 31, wherein: the second set of symbols is adjacent to the first set of symbols.

Clause 33. The wireless communication device of clause 32, wherein: the one or more SL-PRS and the PSCCH are transmitted or received in a same set of resource blocks.

Clause 34. A wireless communication device, comprising: means for receiving or transmitting a physical sidelink control channel (PSCCH) in a slot, wherein the PSCCH spans a first bandwidth in the slot; means for receiving or transmitting a physical sidelink shared channel (PSSCH) in the slot, wherein the PSSCH spans at least a second bandwidth adjacent to the first bandwidth; and means for receiving or transmitting one or more sidelink positioning reference signals (SL-PRS) in the slot, wherein the one or more SL-PRS span a third bandwidth, wherein the third bandwidth corresponds to a sum of the first bandwidth and the second bandwidth.

Clause 35. The wireless communication device of clause 34, wherein: the PSCCH and the PSSCH are transmitted or received in a first set of contiguous symbols; and the one or more SL-PRS are received in a second set of contiguous symbols adjacent to the first set of contiguous symbols.

Clause 36. The wireless communication device of any of clauses 34 to 35, wherein: the PSCCH is transmitted or received in a first set of contiguous symbols; the PSSCH is transmitted or received in the first set of contiguous symbols and a second set of contiguous symbols adjacent to the first set of contiguous symbols; and the one or more SL-PRS are transmitted or received in a third set of contiguous symbols adjacent to the second set of contiguous slots.

Clause 37. The wireless communication device of any of clauses 34 to 36, wherein: the PSSCH includes sidelink control information 2 (SCI-2); a duplicate of at least a subset of information in sidelink control information 1 (SCI-1); sidelink shared channel (SL-SCH) information; or any combination thereof.

Clause 38. The wireless communication device of clause 37, wherein: the PSCCH includes information relating to the one or more SL-PRS.

Clause 39. A wireless communication device, comprising: means for transmitting or receiving a physical sidelink control channel (PSCCH) in one or more symbols of a slot; and means for transmitting or receiving one or more sidelink positioning reference signals (SL-PRS) in the one or more symbols of the slot, wherein the one or more SL-PRS and the PSCCH are frequency division multiplexed within the one or more symbols of the slot and have a same number of symbols.

Clause 40. A non-transitory computer-readable medium storing computer-executable instructions that, when executed by a wireless communication device, cause the wireless communication device to: transmit or receive a physical sidelink control channel (PSCCH); and transmit or receive one or more sidelink positioning reference signals (SL-PRS), wherein the one or more SL-PRS and the PSCCH are transmitted or received with a same bandwidth in a same slot.

Clause 41. The non-transitory computer-readable medium of clause 40, wherein: the one or more SL-PRS and the PSCCH span multiple sub-channels.

Clause 42. The non-transitory computer-readable medium of any of clauses 40 to 41, wherein: the one or more SL-PRS and the PSCCH span a same number of resource blocks.

Clause 43. The non-transitory computer-readable medium of any of clauses 40 to 42, wherein: the one or more SL-PRS and the PSCCH are transmitted or received in a same set of resource blocks.

Clause 44. The non-transitory computer-readable medium of clause 43, wherein: the PSCCH is transmitted or received in a first set of symbols; and the one or more SL-PRS is transmitted or received in a second set of symbols.

Clause 45. The non-transitory computer-readable medium of clause 44, wherein: the second set of symbols is adjacent to the first set of symbols.

Clause 46. The non-transitory computer-readable medium of clause 45, wherein: the one or more SL-PRS and the PSCCH are transmitted or received in a same set of resource blocks.

Clause 47. A non-transitory computer-readable medium storing computer-executable instructions that, when executed by an wireless communication device, cause the wireless communication device to: receive or transmit a physical sidelink control channel (PSCCH) in a slot, wherein the PSCCH spans a first bandwidth in the slot; receive or transmit a physical sidelink shared channel (PSSCH) in the slot, wherein the PSSCH spans at least a second bandwidth adjacent to the first bandwidth; and receive or transmit one or more sidelink positioning reference signals (SL-PRS) in the slot, wherein the one or more SL-PRS span a third bandwidth, wherein the third bandwidth corresponds to a sum of the first bandwidth and the second bandwidth.

Clause 48. The non-transitory computer-readable medium of clause 47, wherein: the PSCCH and the PSSCH are transmitted or received in a first set of contiguous symbols; and the one or more SL-PRS are received in a second set of contiguous symbols adjacent to the first set of contiguous symbols.

Clause 49. The non-transitory computer-readable medium of any of clauses 47 to 48, wherein: the PSCCH is transmitted or received in a first set of contiguous symbols; the PSSCH is transmitted or received in the first set of contiguous symbols and a second set of contiguous symbols adjacent to the first set of contiguous symbols; and the one or more SL-PRS are transmitted or received in a third set of contiguous symbols adjacent to the second set of contiguous slots.

Clause 50. The non-transitory computer-readable medium of any of clauses 47 to 49, wherein: the PSSCH includes sidelink control information 2 (SCI-2); a duplicate of at least a subset of information in sidelink control information 1 (SCI-1); sidelink shared channel (SL-SCH) information; or any combination thereof.

Clause 51. The non-transitory computer-readable medium of clause 50, wherein: the PSCCH includes information relating to the one or more SL-PRS.

Clause 52. A non-transitory computer-readable medium storing computer-executable instructions that, when executed by a wireless communication device, cause the wireless communication device to: transmit or receive a physical sidelink control channel (PSCCH) in one or more symbols of a slot; and transmit or receive one or more sidelink positioning reference signals (SL-PRS) in the one or more symbols of the slot, wherein the one or more SL-PRS and the PSCCH are frequency division multiplexed within the one or more symbols of the slot and have a same number of symbols.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The various illustrative logical blocks, modules, and circuits described in connection with the aspects disclosed herein may be implemented or performed with a general purpose processor, a digital signal processor (DSP), an ASIC, a field-programable gate array (FPGA), or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, for example, a combination of a DSP and a microprocessor, a plurality of microprocessors, one or more microprocessors in conjunction with a DSP core, or any other such configuration.

The methods, sequences and/or algorithms described in connection with the aspects disclosed herein may be embodied directly in hardware, in a software module executed by a processor, or in a combination of the two. A software module may reside in random access memory (RAM), flash memory, read-only memory (ROM), erasable programmable ROM (EPROM), electrically erasable programmable ROM (EEPROM), registers, hard disk, a removable disk, a CD-ROM, or any other form of storage medium known in the art. An example storage medium is coupled to the processor such that the processor can read information from, and write information to, the storage medium. In the alternative, the storage medium may be integral to the processor. The processor and the storage medium may reside in an ASIC. The ASIC may reside in a user terminal (e.g., UE). In the alternative, the processor and the storage medium may reside as discrete components in a user terminal.

In one or more example aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

While the foregoing disclosure shows illustrative aspects of the disclosure, it should be noted that various changes and modifications could be made herein without departing from the scope of the disclosure as defined by the appended claims. The functions, steps and/or actions of the method claims in accordance with the aspects of the disclosure described herein need not be performed in any particular order. Furthermore, although elements of the disclosure may be described or claimed in the singular, the plural is contemplated unless limitation to the singular is explicitly stated.

1. A method of wireless communication performed by a wireless communication device, comprising:
transmitting or receiving a physical sidelink control channel (PSCCH); and transmitting or receiving one or more sidelink positioning reference signals (SL-PRS), wherein the one or more SL-PRS and the PSCCH are transmitted or received with a same bandwidth in a same slot.

2. The method of claim 1, wherein:
the one or more SL-PRS and the PSCCH span multiple sub-channels.

3. The method of claim 1, wherein:
the one or more SL-PRS and the PSCCH span a same number of resource blocks.

4. The method of claim 1, wherein:
the one or more SL-PRS and the PSCCH are transmitted or received in a same set of resource blocks.

5. The method of claim 4, wherein:
the PSCCH is transmitted or received in a first set of symbols; and
the one or more SL-PRS is transmitted or received in a second set of symbols.

6. The method of claim 5, wherein:
the second set of symbols is adjacent to the first set of symbols.

7. The method of claim 6, wherein:
the one or more SL-PRS and the PSCCH are transmitted or received in a same set of resource blocks.

8. A method of wireless communication performed by a wireless communication device, comprising:
receiving or transmitting a physical sidelink control channel (PSCCH) in a slot, wherein the PSCCH spans a first bandwidth in the slot;
receiving or transmitting a physical sidelink shared channel (PSSCH) in the slot, wherein the PSSCH spans at least a second bandwidth adjacent to the first bandwidth; and
receiving or transmitting one or more sidelink positioning reference signals (SL-PRS) in the slot, wherein the one or more SL-PRS span a third bandwidth, wherein the third bandwidth corresponds to a sum of the first bandwidth and the second bandwidth.

9. The method of claim 8, wherein:
the PSCCH and the PSSCH are transmitted or received in a first set of contiguous symbols; and
the one or more SL-PRS are received in a second set of contiguous symbols adjacent to the first set of contiguous symbols.

10. The method of claim 8, wherein:
the PSCCH is transmitted or received in a first set of contiguous symbols; the PSSCH is transmitted or received in the first set of contiguous symbols and a second set of contiguous symbols adjacent to the first set of contiguous symbols; and the one or more SL-PRS are transmitted or received in a third set of contiguous symbols adjacent to the second set of contiguous slots.

11. The method of claim 8, wherein:
the PSSCH includes
sidelink control information 2 (SCI-2);
a duplicate of at least a subset of information in sidelink control information 1 (SCI-1);
sidelink shared channel (SL-SCH) information; or
any combination thereof.

12. The method of claim 11, wherein:
the PSCCH includes information relating to the one or more SL-PRS.

13. (canceled)

14. A wireless communication device, comprising:
a memory;
at least one transceiver; and
at least one processor communicatively coupled to the memory and the at least one transceiver, the at least one processor configured to:
transmit or receive, via the at least one transceiver, a physical sidelink control channel (PSCCH); and
transmit or receive, via the at least one transceiver, one or more sidelink positioning reference signals (SL-PRS), wherein the one or more SL-PRS and the PSCCH are transmitted or received with a same bandwidth in a same slot.

15. The wireless communication device of claim 14, wherein:
the one or more SL-PRS and the PSCCH span multiple sub-channels.

16. The wireless communication device of claim 14, wherein:
the one or more SL-PRS and the PSCCH span a same number of resource blocks.

17. The wireless communication device of claim 14, wherein:
the one or more SL-PRS and the PSCCH are transmitted or received in a same set of resource blocks.

18. The wireless communication device of claim 17, wherein:
the PSCCH is transmitted or received in a first set of symbols; and
the one or more SL-PRS is transmitted or received in a second set of symbols.

19. The wireless communication device of claim 18, wherein:
the second set of symbols is adjacent to the first set of symbols.

20. The wireless communication device of claim 19, wherein:
the one or more SL-PRS and the PSCCH are transmitted or received in a same set of resource blocks.
